(19) United States
(12) Patent Application Publication
(10) Pub. No.: US 2025/0043086 A1
(43) Pub. Date: Feb. 6, 2025

(54) METHODS OF PREPARING A COMPOSITE HAVING RESINS

(71) Applicant: Beyond Lotus LLC, Wilmington, DE (US)

(72) Inventors: Ping Zhang, Westford, MA (US); Michael Beaulieu, Bolton, MA (US); Brian N. Hult, Plaistow, NH (US); Dhaval A. Doshi, Lexington, MA (US)

(21) Appl. No.: 18/716,614

(22) PCT Filed: Dec. 7, 2022
(86) PCT No.: PCT/US2022/081072

§ 371 Date: Jun. 5, 2024

Related U.S. Application Data
(60) Provisional application No. 63/287,383, filed on Dec. 8, 2021.

(51) Int. Cl. C08J 3/205; C08J 3/22; C08J 3/24; C08K 3/04; C08K 3/06; C08K 3/24; C08K 5/47; C08K 9/06; C08L 7/00; C08L 9/06

(52) U.S. Cl. CPC C08J 3/2053; C08J 3/247; C08K 3/04; C08K 3/06; C08K 3/24; C08K 5/47; C08K 9/06; C08L 7/00; C08L 9/06; C08J 3/22; C08J 2307/00; C08J 2325/10; C08J 2423/20; C08J 2493/04

(57) ABSTRACT

Disclosed herein are methods of preparing a composite, comprising mixing a solid elastomer, a wet filler, and a resin. Single-stage or multi-stage mixing methods can be used. Also disclosed are composite comprising the filler dispersed in the elastomer at a loading of at least 20 phr, wherein the composite has a liquid content of no more than 10% by weight based on total weight of said composite.

### FIELD OF THE INVENTION

Disclosed herein are methods of preparing composite by combining solid elastomer and wet filler and resins. Also disclosed are corresponding vulcanizates derived from these composites.

### BACKGROUND

There is always a desire in the rubber industry to develop methods to disperse filler in elastomer and it is especially desirable to develop methods which can do so efficiently with respect to filler dispersion quality, time, effort, and/or cost.

Numerous products of commercial significance are formed of elastomeric compositions wherein reinforcing filler is dispersed in any of various synthetic elastomers, natural rubber or elastomer blends. Carbon black and silica, for example, are widely used to reinforce natural rubber and other elastomers. It is common to produce a masterbatch, that is, a premixture of reinforcing filler, elastomer, and various optional additives, such as extender oil. Such masterbatches are then compounded with processing and curing additives and upon curing, generate numerous products of commercial significance. Such products include, for example, pneumatic and non-pneumatic or solid tires for vehicles, including the tread portion including cap and base, undertread, innerliner, sidewall, wire skim, carcass and others. Other products include, for example, engine mounts, bushings, conveyor belts, windshield wipers, rubber components for aerospace and marine equipment, vehicle track elements, seals, liners, gaskets, wheels, bumpers, anti-vibration systems and the like.

While there are a number of methods to incorporate filler into solid elastomer, there is a continuing need for new methods to achieve acceptable or enhanced elastomer composite dispersion quality and functionality from elastomer composite masterbatches, which can translate into acceptable or enhanced properties in the corresponding vulcanized rubber compounds and rubber articles.

### SUMMARY

One aspect is a method of preparing a composite, comprising:
(a) charging a mixer with at least a solid elastomer, a wet filler comprising a filler (e.g., silica and/or carbon black and/or silicon-treated carbon black) and a liquid present in an amount of at least 15% by weight based on total weight of the wet filler, and a resin;
(b) in one or more mixing steps, mixing the at least the solid elastomer, the wet filler, and the resin to form a mixture, and removing at least a portion of the liquid from the mixture by evaporation; and
(c) discharging, from the mixer, the composite comprising the filler dispersed in the elastomer at a loading of at least 20 phr, wherein the composite has a liquid content of no more than 10% by weight based on total weight of said composite.

Another aspect is a method of preparing a composite, comprising:
(a) charging a first mixer with at least a solid elastomer and a wet filler comprising a filler (e.g., silica and/or carbon black and/or silicon-treated carbon black) and a liquid present in an amount of at least 20% by weight based on total weight of wet filler;
(b) in one or more mixing steps, mixing the at least the solid elastomer and the wet filler to form a mixture, and removing at least a portion of the liquid from the mixture by evaporation;
(c) discharging, from the first mixer, the mixture comprising the filler dispersed in the elastomer at a loading of at least 20 phr, wherein the mixture has a liquid content that is reduced to an amount less than the liquid content at the beginning of step (b), and wherein the mixture has a material temperature ranging from 100° C. to 180° C.;
(d) mixing the mixture from (c) in a second mixer to obtain the composite; and
(e) discharging, from the second mixer, the composite having a liquid content of less than 3% by weight based on total weight of said composite,
wherein a resin is charged to the first mixer, the second mixer, or both the first and second mixers.

With regard to any aspect or method or embodiment disclosed herein, where applicable, the method can further comprise any one or more of the following embodiments: the resin has a T_{g} of at least 25° C. or ranging from 25° C. to 110° C.; the resin has a softening point at least 50° C., or ranging from 50° C. to 150° C., as determined according to ASTM E-28; the resin is selected from one or more of C5 resins, C5/C9 resins, C9 resins, rosin resins, terpene resins, aromatic-modified terpene resins, dicyclopentadiene resins, alkylphenol resins, and combinations thereof.

With regard to any aspect or method or embodiment disclosed herein, where applicable, the method can further comprise any one or more of the following embodiments: the charging comprises charging the mixer with separate charges of the resin and the wet filler; the charging comprises multiple additions of the solid elastomer, the wet filler, and/or the resin; the charging comprises introducing dry filler into the mixer, wherein the dry filler is wetted by adding the liquid to form the wet filler in the mixer; said mixing is performed in one mixing step; said mixing is performed in two or more mixing steps; the mixing in (b) is a second mixing step, wherein a first mixing step comprises mixing at least a portion of the solid elastomer and at least a portion of the wet filler followed by charging the mixer with the resin; the charging in (a) comprises charging the mixer with a mixture comprising the resin and the wet filler; the charging in (a) comprises charging the mixer with a co-pellet comprising the resin and the wet filler.

With regard to any aspect or method or embodiment disclosed herein, where applicable, the method can further comprise any one or more of the following embodiments: wherein in at least one of the mixing steps, the method comprises conducting said mixing wherein the mixer has at least one temperature-control means that is set to a temperature, T_{z}, of 65° C. or higher; wherein in at least one of the mixing steps, the method comprises conducting said mixing with one or more rotors of the mixer operating at a tip speed of at least 0.6 m/s for at least 50% of mixing time.

With regard to any aspect or method or embodiment disclosed herein, where applicable, the method can further comprise any one or more of the following embodiments: the wet filler is selected from at least one material selected from carbonaceous materials, silica, nanocellulose, lignin, clays, nanoclays, metal oxides, metal carbonates, pyrolysis carbon, graphenes, graphene oxides, reduced graphene oxide, carbon nanotubes, single-wall carbon nanotubes, multi-wall carbon nanotubes, or other fillers disclosed herein or combinations thereof, and coated and treated materials thereof; the wet filler comprises silica; the wet filler comprises silica in an amount of at least 50% by weight relative to the total weight of the filler, and the wet filler further comprises carbon black and/or silicon-treated carbon black; the wet filler has a liquid present in an amount ranging from 20% to 80% by weight based on total weight of wet filler; the wet filler is in the form of a powder, paste, pellet, or cake.

With regard to any aspect or method or embodiment disclosed herein, where applicable, the method can further comprise any one or more of the following embodiments: the solid elastomer is selected from natural rubber, functionalized natural rubber, styrene-butadiene rubber, functionalized styrene-butadiene rubber, polybutadiene rubber, functionalized polybutadiene rubber, polyisoprene rubber, ethylene-propylene rubber, isobutylene-based elastomers, polychloroprene rubber, nitrile rubber, hydrogenated nitrile rubber, polysulfide rubber, polyacrylate elastomers, fluoroelastomers, perfluoroelastomers, silicone elastomers, and blends thereof; the solid elastomer is selected from natural rubber, functionalized natural rubber, styrene-butadiene rubber, functionalized styrene-butadiene rubber, polybutadiene rubber, functionalized polybutadiene rubber, and blends thereof.

With regard to any aspect or method or embodiment disclosed herein, where applicable, the method can further comprise any one or more of the following embodiments: the one or more mixing steps is a continuous process; one or more mixing steps is a batch process; the resin is charged to a first mixer and step (b) comprises mixing the at least the solid elastomer, the wet filler, and the resin to form the mixture; the resin is charged to the second mixer and step (d) comprises mixing the mixture from (c) and the resin in the second mixer to obtain the composite; the first and second mixers are the same; the first and second mixers are different; the second mixer is operated under at least one of the following conditions: (i) a ram pressure of 5 psi or less; (ii) a ram raised to at least 75% of its highest level; (iii) a ram operated in floating mode; (iv) a ram positioned such that it does not substantially contact the mixture; (v) the mixer is ram-less; and (vi) a fill factor of the mixture ranges from 25% to 70%; the second mixer is operated under at least one of the following conditions (i) to (vi) for at least 50% of the mixing time.

Another aspect provides a method of preparing a vulcanizate, comprising: curing the composite prepared by the method of any one of claims 1-32 in the presence of at least one curing agent to form the vulcanizate. Also disclosed are vulcanizates prepared from the composites disclosed herein, and articles comprising such vulcanizates.

### DETAILED DESCRIPTION

Certain rubber compounds, such as those containing solution styrene-butadiene rubber (SBR) or blends of solution SBR and butadiene rubber (BR) in combination with silica or a silica/carbon black blend, can have applications in passenger and light truck (PC/LT) treads for reduced rolling resistance and enhanced wet traction. There is a recent trend to move toward electrical vehicles (EVs). In addition to SBR, or SBR/BR blends, compositions comprising natural rubber and silica can potentially be used for PC/LT tread compounds for tires used for EVs, since natural rubber is known for high tear and high mechanical strength and silica can provide reduced rolling resistance.

There is, however, a need to reduce the rolling resistance of tires to extend the driving distance of EVs. Compared with tires used in internal combustion engine-powered vehicles, tires used for EVs are subjected to heavier load and higher torque. Such tires can experience more severe mechanical stresses and consequently, can wear out more quickly. There is therefore a need to develop new tread compositions for tires that provide EVs with reduced rolling resistance while maintaining or even improving the treadwear performance.

Natural rubber/silica compositions can be a good choice for PC/LT compounds and tires used for EVs as natural rubber is known for high tear and high mechanical strength. There are challenges in developing natural rubber-based silica compositions. Natural rubber/silica compounds prepared from the conventional mixing process may exhibit poor reinforcement properties and can show deteriorated treadwear performance compared with natural rubber/carbon black compounds (e.g., see U.S. Pat. No. 9,758,645).

PCT Publ. No. WO 2020/247663, the disclosure of which is incorporated by reference herein, describes mixing processes with solid elastomer and a wet filler (e.g., comprising a filler and a liquid) to enable the batch time and temperature to be controlled beyond that attainable with known dry mixing processes. Other benefits may be attained, such as enhancing filler dispersion and/or facilitating rubber-filler interactions and/or improving rubber compound properties compared to conventionally mixed masterbatches when they are compounded and vulcanized. One or more properties can be improved, e.g., the ratio of tensile stress at 300% elongation to stress at 100% elongation (M300/M100), and the tangent delta (tan δ) measured at 60° C. Such wet mixing process (single or multi-stage mixing) can be used to prepare elastomer compositions, such as SBR, BR, natural rubber-based compositions, e.g., natural rubber/silica compositions, with the potential of enhanced reinforcement properties and/or reduced hysteresis loss at high temperature compared with rubber compositions produced by dry mix processes.

Certain performance attributes for tires, such as wet traction or wet gripping performance, can be enhanced by the incorporation of resins (e.g., tackifiers, traction resins, thermoplastic resins) in the rubber composition. The incorporation of resins in certain passenger and truck treads containing BR, optionally in combination with SBR and/or NR, can result in improved wear performance without compromising wet traction.

Disclosed herein are processes for mixing wet filler, solid elastomer, and one or more resins. Also disclosed are composites and vulcanizates produced from such processes. Generally for tires, there is a correlation between properties such as glass transition temperature (T_{g}) and wet gripping performance. Certain resins having suitable T_{g} values can be selected to modify the viscoelastic properties of the rubber composition and optimize performance attributes such as wet gripping performance. Processes for incorporating resins in a wet mixing method can potentially produce elastomer compositions that can lead to passenger and light truck tire treads having improved treadwear and/or reduced rolling resistance.

One aspect is directed to methods for making a composite comprising:
(a) charging a mixer with at least a solid elastomer, a wet filler comprising a filler and a liquid present in an amount of at least 15% by weight based on total weight of the wet filler, and a resin;
(b) in one or more mixing steps, mixing the at least the solid elastomer, the wet filler, and the resin to form a mixture, and removing at least a portion of the liquid from the mixture by evaporation; and
(c) discharging, from the mixer, the composite comprising the filler dispersed in the elastomer at a loading of at least 20 phr, wherein the composite has a liquid content of no more than 10% by weight based on total weight of said composite.

The composite formed by the methods disclosed herein can be considered an uncured mixture of filler(s) and elastomer(s), e.g., an uncured mixture of filler(s), elastomer(s), and resin(s). The composite formed can be considered a mixture or masterbatch. The composite formed can be, as an option, an intermediate product that can be used in subsequent rubber compounding and one or more vulcanization processes. The composite, prior to the compounding and vulcanization, can also be subjected to additional processes, such as one or more holding steps or further mixing step(s), one or more additional drying steps, one or more extruding steps, one or more calendaring steps, one or more milling steps, one or more granulating steps, one or more baling steps, one or more twin-screw discharge extruding steps, or one or more rubber working steps to obtain a rubber compound or a rubber article.

As stated herein, resins can influence the viscoelastic properties of the rubber composition and can enhance properties such as wet traction performance. The resins disclosed herein are selected for compatibility with the solid elastomer as well as the desired application. The resins can be a solid having certain desired properties of glass transition temperature (T_{g}) and softening point. The T_{g} of the resin can be selected to modify the T_{g} of the resulting composite and consequently the rubber compound (vulcanizate). As an option, suitable T_{g} for the resins to be incorporated in the disclosed processes can be at least 25° C., at least 30° C., at least 35° C., at least 40° C., or at least 50° C., or can range from 25° C. to 110° C., from 35° C. to 110° C., from 40° C. to 110° C., from 25° C. to 100° C., from 35° C. to 100° C., from 40° C. to 100° C., from 25° C. to 90° C., from 35° C. to 90° C., from 40° C. to 90° C., from 25° C. to 80° C., from 35° C. to 80° C., from 40° C. to 80° C., from 25° C. to 70° C., from 35° C. to 70° C., from 40° C. to 70° C., from 25° C. to 65° C., from 35° C. to 65° C., or from 40° C. to 65° C.

Another consideration in addition to T_{g} is softening point of the resin, which can also affect the viscoelasticity. Softening points are generally defined as the temperature at which the resin transforms from a brittle or slow-flowing material to a softer and less viscous liquid. The softening point of resins can be determined with a Ring and Ball apparatus, as outlined in ASTM E-28 (ring and ball softening points). Suitable softening points for the resins be at least 50° C., at least 60° C., at least 70° C., or can range from 50° C. to 150° C., from 60° C. to 150° C., from 70° C. to 150° C., from 80° C. to 150° C., from 50° C. to 125° C., from 60° C. to 125° C., from 70° C. to 125° C., from 80° C. to 125° C., from 50° C. to 110° C., from 60° C. to 110° C., from 70° C. to 110° C., or from 80° C. to 110° C., determined according to ASTM E-28. The resin can be compatible or incompatible with the elastomer in the composition depending on the desired performance attribute.

Resins can be selected based on the application and/or elastomer type. Numerous resin types are available, such as resins derived from petroleum cracking, wood feedstock, etc. Hydrocarbon resins are produced from petroleum feedstocks and can be aliphatic- or aromatic-based resins. Aliphatic resins include C5 resins having monomers with five carbon atoms. Aromatic resins include C9 resins containing nine-carbon aromatic monomers or a mixture of C8-C10 aromatic monomers. C5/C9 resins are aliphatic and aromatic resins as they have both C5 and C9 comonomers. In tire applications, C5, C9, and C5/C9 resins can be used to enhance wet gripping performance. Commercially available C5, C9, and C5/C9 resins include, for example, those resins sold under the tradename Impera™ resins or Picco™ resins such as Impera™ R1607 resin (C5), Impera™ G1750 resin (C9), and Impera™ D1606 resin (C5/C9) (Eastman Chemical Co). Rosin resins are derived from, e.g., wood sources (e.g., trees) or from papermaking processes. Commercially available rosin resins include, for example, those resins sold under the tradename Permalyn™ resins, such as Permalyn™ 5095 resin (Eastman Chemical Co). Terpene resins are produced from terpene feedstocks (e.g., from wood, turpentine, etc.). Terpene resins can be modified with aromatic groups, e.g., C9 monomers, to form aromatic-modified terpene resins. Rosin, terpene, and aromatic-modified terpene resins can enhance wet gripping performance and steering ability. Other suitable resins can be formed by dimerizing cyclopentadienes (dicyclopentadiene resins), or by condensing alkylphenols and formaldehyde (alkylphenol resins), or by condensing alkylphenol and acetylene. Combinations of different resin types can also be used. Resins suitable for tire and other elastomer-based applications are also found in U.S. Pat. Nos. 10,738,178, 10,745,545, and U.S. Pat. Publ. No. 2015/0283854, the disclosures of which are incorporated by reference herein. As an option, the resin can be selected from one or more of C5 resins, C5/C9 resins, C9 resins, rosin resins, terpene resins, aromatic-modified terpene resins, dicyclopentadiene resins, alkylphenol resins, and combinations (e.g., blends, mixtures) thereof.

The resin loading (e.g., amount of resin charged to the mixer or amount of resin present in the composite) can be at least 5 phr, at least 10 phr, at least 20 phr and optionally up to 100 phr, e.g., an amount ranging from 5 phr to 100 phr, e.g., from 5 phr to 75 phr, from 5 phr to 50 phr, from 5 phr to 25 phr, from 5 phr to 20 phr, or from 5 phr to 15 phr.

The methods for preparing a composite include the step of charging or introducing into a mixer at least a solid elastomer (one or more solid elastomers) and a wet filler. The combining of the solid elastomer with wet filler forms a mixture during the mixing step(s). The method further includes, in one or more mixing steps, conducting said mixing wherein at least a portion of the liquid is removed by evaporation or an evaporation process that occurs during the mixing. The liquid of the wet filler is capable of being removed by evaporation (and at least a portion is capable of being removed under the claimed mixing conditions) and can be a volatile liquid, e.g., volatile at bulk mixture temperatures. For example, a volatile liquid can be distinguished from oils (e.g., extender oils, process oils) which can be present during at least a portion of the mixing as such oils are meant to be present in the composite that is discharged and thus, do not evaporate during a substantial portion of the mixing time.

The filler charged to the mixer comprises a wet filler. In their dry state, fillers may contain no or small amounts of liquid (e.g. water or moisture) adsorbed onto its surfaces. For example, carbon black can have 0 wt. %, or 0.1 wt. % to 1 wt. % or up to 3 wt. % or up to 4 wt. % of liquid and precipitated silica can have a liquid (e.g., water or moisture) content of from 4 wt. % to 7 wt. % liquid, e.g., from 4 wt. % to 6 wt. % liquid. Such fillers are referred to herein as dry or non-wetted fillers. Under certain conditions, e.g., conditions of high humidity, silica can have a water or moisture content as high as 10%. As an option, the dry filler has a liquid content of no more than 10% by weight (e.g., ranging from 4 wt. % to 10 wt. %) relative to the total weight of filler and liquid. In other options, the dry filler has a liquid content of no more than 8 wt. % (e.g., ranging from 4 wt. % to 8 wt. %), no more than 7 wt. %, no more than 6 wt. %, no more than 5 wt. %, no more than 4 wt. %, no more than 3 wt. %, no more than 2 wt. %, or no more than 1 wt. %. For example, the filler is silica and has a liquid (e.g., water) content of no more than 10 wt. % (e.g., ranging from 4 wt. % to 10 wt. %), or no more than 6 wt. %.

For the present wet fillers, liquid or additional liquid can be added to the filler and is present on a substantial portion or substantially all the surfaces of the filler, which can include inner surfaces or pores accessible to the liquid. Thus, sufficient liquid is provided to wet a substantial portion or substantially all of the surfaces of the filler prior to mixing with solid elastomer. During mixing, at least a portion of the liquid can also be removed by evaporation as the wet filler is being dispersed in the solid elastomer, and the surfaces of the filler can then become available to interact with the solid elastomer. The wet filler can have a liquid content of at least 15% by weight or at least 20% by weight relative to the total weight of the wet filler, e.g., at least 25%, at least 30%, at least 40%, at least 50% by weight, or from 20% to 99%, from 20% to 95%, from 20% to 90%, from 20% to 80%, from 20% to 70%, from 20% to 60%, from 30% to 99%, from 30% to 95%, from 30% to 90%, from 30% to 80%, from 30% to 70%, from 30% to 60%, from 40% to 99%, from 40% to 95%, from 40% to 90%, from 40% to 80%, from 40% to 70%, from 40% to 60%, from 45% to 99%, from 45% to 95%, from 45% to 90%, from 45% to 80%, from 45% to 70%, from 45% to 60%, from 50% to 99%, from 50% to 95%, from 50% to 90%, from 50% to 80%, from 50% to 70%, or from 50% to 60% by weight, relative to the total weight of the wet filler. Liquid content of filler can be expressed as weight percent: 100*[mass of liquid]/[mass of liquid+mass of dry filler]. As another option, the amount of liquid can be determined based on the oil adsorption number (OAN) of the filler, where OAN is determined based on ASTM D2414. OAN is a measure of filler structure and can be used in determining the amount of liquid to wet the filler. For example, a wet filler such as a wet carbon black, wet silica (e.g., precipitated silica), or wet silicon-treated carbon black can have a liquid content determined according to the equation: k*OAN/(100+OAN)*100. In one embodiment, k ranges from 0.3 to 1.1, or from 0.5 to 1.05, or from 0.6 to 1.1, or from 0.7 to 1.1, or from 0.8 to 1.1, or from 0.9 to 1.1, or from 0.6 to 1.0, or from 0.7 to 1.0, or from 0.8 to 1.0, or from 0.8 to 1.05, or from 0.9 to 1.0, or from 0.95 to 1, or from 0.95 to 1.1, or from 1.0 to 1.1. As an option, the wet filler has a liquid content ranging from 20% to 80%, from 30% to 70%, from 30% to 60%, from 40% to 70%, or from 40% to 60%.

As an option, the wet filler has the consistency of a solid. As an option, a dry filler is wetted only to an extent such that the resulting wet filler maintains the form of a powder, particulates, pellet, cake, or paste, or similar consistency and/or has the appearance of a powder, particulates, pellet, cake, or paste. The wet filler does not flow like a liquid (at zero applied stress). As an option, the wet filler can maintain a shape at 25° C. when molded into such a shape, whether it be the individual particles, agglomerates, pellets, cakes, or pastes. The wet filler is not a composite made by a liquid masterbatch process and is not any other pre-blended composite of filler dispersed in a solid elastomer (from elastomer in a liquid state) in which the elastomer is the continuous phase. The wet filler is not a slurry of filler and does not have the consistency of a liquid or slurry.

The liquid used to wet the filler can be, or include, an aqueous liquid, such as, but not limited to, water. The liquid can include at least one other component, such as, but not limited to, a base(s), an acid(s), a salt(s), a solvent(s), a surfactant(s), a coupling agent(s) (e.g., if the filler further comprises silica), and/or a processing aid(s) and/or any combinations thereof. More specific examples of the component are NaOH, KOH, acetic acid, formic acid, citric acid, phosphoric acid, sulfuric acid, or any combinations thereof. For example, the base can be selected from NaOH, KOH, and mixtures thereof, or the acids can be selected from acetic acid, formic acid, citric acid, phosphoric acid, or sulfuric acid, and combinations thereof. The liquid can be or include a solvent(s) that is immiscible with the elastomer used (e.g., alcohols such as ethanol). Alternatively, the liquid consists of from about 80 wt. % to 100 wt. % water or from 90 wt. % to 99 wt. % water based on the total weight of the liquid.

In the methods disclosed herein, at least the solid elastomer, wet filler, and resin are charged (e.g. fed, introduced) into the mixer. The charging of the solid elastomer and/or the filler and/or the resin can occur in one or multiple steps or additions. The charging can occur in any fashion including, but not limited to, conveying, metering, dumping and/or feeding in a batch, semi-continuous, or continuous flow of the solid elastomer and the wet filler into the mixer. The solid elastomer and wet filler are not introduced as a pre-mixture to the mixer, in which the pre-mixture was prepared by means other than combining solid elastomer and wet filler. The solid elastomer and wet filler can be added together but not as a mixture prepared by means other than combining solid elastomer and wet filler (e.g., not where the wet filler is pre-dispersed into the elastomer by means other than combining solid elastomer and wet filler, in which the elastomer is the continuous phase). A mixture or pre-mixture or pre-blend from solid elastomer, wet filler, and resin can be charged to the mixer and can be prepared by any number of known methods, e.g., in a mixer or a container.

The charging of the solid elastomer, the wet filler, and the resin can occur all at once, or sequentially, and can occur in any sequence. The charging can comprise separate charges of the solid elastomer, the resin, and the wet filler. Alternatively, the charging can comprise charging a mixture comprising the wet filler and resin. For example, (a) all solid elastomer added first, (b) all wet filler added first (either alone or as a mixture with resin), (c) all solid elastomer added first with a portion of wet filler and resin followed by the addition of one or more remaining portions of wet filler and resin, (d) a portion of solid elastomer added and then a portion of wet filler and/or resin added (e.g., mixture of wet filler and resin), (e) at least a portion of the wet filler is added first followed by at least a portion of the solid elastomer and/or at least a portion of the resin, (f) at the same time or about the same time, a portion of solid elastomer, a portion of wet filler, and a portion of resin are added as separate charges to the mixer, or (g) at least a portion of solid elastomer and at least a portion of wet filler are added in any order and in one or more portions, mixing the at least a portion of solid elastomer and at least a portion of wet filler, charging the mixer with at least a portion of resin, and mixing the solid elastomer, wet filler, and resin to form the mixture.

Other applicable methods of charging the mixer with the solid elastomer and wet filler are disclosed in PCT Publ. No. WO 2020/247663, the disclosure of which is incorporated by reference herein.

With regards to a mixture comprising the wet filler and resin, the mixture can be a particulate mixture of wet filler and resin, e.g., a powder. The resin can be coated onto or combined with the wet filler by solution or dispersion, e.g., aqueous solution or aqueous dispersion. The powder can be charged to the mixer as is, or can be formed into a pellet, i.e., a pellet that is a mixture comprising the resin. As another option, a solution or dispersion containing the resin can be combined with the filler (e.g., fluffy carbon black, silica, silicon-treated carbon black, and/or other filler types). In addition to the combining, the solution can also wet the filler to form the wet filler. The resulting wet filler can then be fed to a pin pelletizer and pelletized via the methods disclosed herein.

The filler in general, can be any conventional filler used with elastomers such as reinforcing fillers including, but not limited to, carbon black, silica, a filler comprising carbon black, a filler comprising silica, and/or any combinations thereof. The filler can be particulate or fibrous or plate-like. For example, a particulate filler is made of discrete bodies. Such fillers can often have an aspect ratio (e.g., length to diameter) of 3:1 or less, or 2:1 or less, or 1.5:1 or less. Fibrous fillers can have an aspect ratio of, e.g., 2:1 or more, 3:1 or more, 4:1 or more, or higher. Typically, fillers used for reinforcing elastomers have dimensions that are microscopic (e.g., hundreds of microns or less) or nanoscale (e.g., less than 1 micron). In the case of carbon black, the discrete bodies of particulate carbon black refer to the aggregates or agglomerates formed from primary particles, and not to the primary particles themselves. In other embodiments, the filler can have a platelike structure such as graphenes and reduced graphene oxides.

The filler can be selected from selected from carbonaceous materials, carbon black, silica, nanocellulose, lignin, clays, nanoclays, metal oxides, metal carbonates, pyrolysis carbon, reclaimed carbon, recovered carbon black (e.g., as defined in ASTM D8178-19, rCB), graphenes, graphene oxides, reduced graphene oxide (e.g., reduced graphene oxide worms as disclosed in PCT Publ. No. WO 2019/070514A1, the disclosure of which is incorporated by reference herein), or densified reduced graphene oxide granules (as disclosed in U.S. Prov. Appl. No. 62/857,296, filed Jun. 5, 2019, and PCT Publ. No. 2020/247681, the disclosures of which are incorporated by reference herein), carbon nanotubes, single-wall carbon nanotubes, multi-wall carbon nanotubes, or combinations thereof, or corresponding coated materials (e.g., silicon-treated carbon black) or chemically-treated materials thereof (e.g., chemically-treated carbon black). Other suitable fillers include carbon nanostructures (CNSs, singular CNS), a plurality of carbon nanotubes (CNTs) that are crosslinked in a polymeric structure by being branched, e.g., in a dendrimeric fashion, interdigitated, entangled and/or sharing common walls with one another. CNS fillers are described in U.S. Pat. No. 9,447,259, and PCT Appl. No. PCT/US2021/027814, the disclosures of which are incorporated by reference herein. Blends of fillers can also be used, e.g., blends of silica and carbon black, silica and silicon-treated carbon black, and carbon black and silicon-treated carbon black. The filler can be chemically treated (e.g. chemically treated carbon black, chemically treated silica, silicon-treated carbon black) and/or chemically modified. The filler can be or include carbon black having an attached organic group(s). The filler can have one or more coatings present on the filler (e.g. silicon-coated materials, silica-coated material, carbon-coated material). The filler can be oxidized and/or have other surface treatments. There is no limitation with respect to the type of filler (e.g., silica, carbon black, or other filler) that can be used.

As mentioned previously, fibrous fillers can also be incorporated in the methods disclosed herein, including natural fibers, semi-synthetic fibers, and/or synthetic fibers (e.g., nanosized carbon filaments), such as short fibers disclosed in PCT Publ. No. WO 2021/153643, the disclosure of which is incorporated by reference herein. Other fibrous fillers include poly(p-phenylene terephthalamide) pulp, commercially available as Kevlar® pulp (Du Pont).

Other suitable fillers include bio-sourced or bio-based materials (derived from biological sources), recycled materials, or other fillers considered to be renewable or sustainable include hydrothermal carbon (HTC, where the filler comprises lignin that has been treated by hydrothermal carbonization as described in U.S. Pat. Nos. 10,035,957, and 10,428,218, the disclosures of which are incorporated by reference, herein), rice husk silica, carbon from methane pyrolysis, nanocrystalline cellulose starch particles, polysaccharides, glucans, dextrans, microfibrillated cellulose, engineered polysaccharide particles, starch, siliceous earth, crumb rubber, and functionalized crumb rubber. Exemplary engineered polysaccharides include those described in U.S. Pat. Publ. Nos. 2020/0181370 and 2020/0190270, the disclosures of which are incorporated herein by reference. For example, the polysaccharides can be selected from: poly alpha-1,3-glucan; poly alpha-1,3-1,6-glucan; a water insoluble alpha-(1,3-glucan) polymer having 90% or greater α-1,3-glycosidic linkages, less than 1% by weight of alpha-1,3,6-glycosidic branch points, and a number average degree of polymerization in the range of from 55 to 10,000; dextran; a composition comprising a poly alpha-1,3-glucan ester compound; and water-insoluble cellulose having a weight-average degree of polymerization (DPw) of about 10 to about 1000 and a cellulose II crystal structure.

The carbon black can be a furnace black, a gas black, a thermal black, an acetylene black, or a lamp black, a plasma black, a recovered carbon black (e.g., as defined in ASTM D8178-19), or a carbon product containing silicon-containing species, and/or metal containing species and the like. The carbon black used in any of the methods disclosed herein can be any grade of reinforcing carbon blacks and semi-reinforcing carbon blacks. Examples of ASTM grade reinforcing grades are N110, N121, N134, N220, N231, N234, N299, N326, N330, N339, N347, N351, N358, and N375 carbon blacks. Examples of ASTM grade semi-reinforcing grades are N539, N550, N650, N660, N683, N762, N765, N774, N787, N990 carbon blacks and/or N990 grade thermal blacks.

The carbon black can have any statistical thickness surface area (STSA) such as ranging from 20 m²/g to 250 m²/g or higher. STSA (statistical thickness surface area) is determined based on ASTM Test Procedure D-5816 (measured by nitrogen adsorption). The carbon black can have a compressed oil absorption number (COAN) ranging from about 30 mL/100 g to about 150 mL/100 g. Compressed oil absorption number (COAN) is determined according to ASTM D3493. As an option, the carbon black can have a STSA ranging from 20 m²/g to 180 m²/g, or from 60 m²/g to 150 m²/g with a COAN ranging from 40 mL/100 g to 115 mL/100 g or from 70 mL/100 g to 115 mL/100 g.

As stated, the carbon black can be a rubber black, and especially a reinforcing grade of carbon black or a semi-reinforcing grade of carbon black. Carbon blacks sold under the Regal®, Black Pearls®, Spheron®, Sterling®, Propel®, Endure®, and Vulcan® trademarks available from Cabot Corporation, the Raven®, Statex®, Furnex®, and Neotex® trademarks and the CD and HV lines available from Birla Carbon (formerly available from Columbian Chemicals), and the Corax®, Durax®, Ecorax®, and Purex® trademarks and the CK line available from Orion Engineered Carbons (formerly Evonik and Degussa Industries), and other fillers suitable for use in rubber or tire applications, may also be exploited for use with various implementations. Suitable chemically functionalized carbon blacks include those disclosed in WO 96/18688 and US2013/0165560, the disclosures of which are hereby incorporated by reference. Mixtures of any of these carbon blacks may be employed. Carbon blacks having surface areas and structures beyond the ASTM grades and typical values selected for mixing with rubber, such as those described in U.S. Patent Application Publ. No. 2018/0282523, the disclosure of which is incorporated herein by reference, may be used in the wet filler and in the composite made by any of the methods disclosed herein.

With regard to the filler, as an option, being at least silica, one or more types of silica, or any combination of silica(s), can be used in any embodiment disclosed herein. The silica can include or be precipitated silica, fumed silica, silica gel, and/or colloidal silica. The silica can be or include untreated silica and/or chemically-treated silica. The silica can be suitable for reinforcing elastomer composites and can be characterized by a Brunaur Emmett Teller surface area (BET, as determined by multipoint BET nitrogen adsorption, ASTM D1993) of about 20 m²/g to about 450 m²/g; about 30 m²/g to about 450 m²/g; about 30 m²/g to about 400 m²/g; or about 60 m²/g to about 250 m²/g, from about 60 m²/g to about 250 m²/g, from about 80 m²/g to about 200 m²/g. The silica can have an STSA ranging from about 80 m²/g to 250 m²/g, such as from about 80 m²/g to 200 m²/g or from 90 m²/g to 200 m²/g, from 80 m²/g to 175 m²/g, or from 80 m²/g to 150 m²/g. Highly dispersible precipitated silica can be used as the filler in the present methods. Highly dispersible precipitated silica (“HDS”) is understood to mean any silica having a substantial ability to dis-agglomerate and disperse in an elastomeric matrix. Such dispersion determinations may be observed in known manner by electron or optical microscopy on thin sections of elastomer composite. Examples of commercial grades of HDS include, Perkasil® GT 3000GRAN silica from WR Grace & Co, Ultrasil® 7000 silica from Evonik Industries, Zeosil® 1165 MP, 1115 MP, Premium, and 1200 MP silica from Solvay S.A., Hi-Sil® EZ 160G silica from PPG Industries, Inc., and Zeopol® 8741 or 8745 silica from Evonik Industries. Conventional non-HDS precipitated silica may be used as well. Examples of commercial grades of conventional precipitated silica include, Perkasil® KS 408 silica from WR Grace & Co, Zeosil® 175GR silica from Solvay S.A., Ultrasil® VN3 silica from Evonik Industries, and Hi-Sil® 243 silica from PPG Industries, Inc. Precipitated silica with surface attached silane coupling agents may also be used. Examples of commercial grades of chemically-treated precipitated silica include Agilon® 400, 454, or 458 silica from PPG Industries, Inc. and Coupsil silicas from Evonik Industries, for example Coupsil® 6109 silica.

While the liquid amount in the filler as described above can equally apply to silica, as a more particular example, when silica is used as the wet filler in part or in whole as the wet filler, the silica can have liquid present in an amount of from about 25 wt. % to about 75 wt. %, e.g., from about 30% to about 75%, from about 40% to about 75%, from about 45% to about 75%, from about 50% to about 75%, from about 30% to about 70%, from about 40% to about 70%, from about 45% to about 70%, from about 50% to about 70%, from about 30% to about 65%, from about 40% to about 65%, from about 45% to about 65%, from about 50% to about 65%, from about 30% to about 60% by weight, from about 40% to about 60%, from about 45% to about 60%, or from about 50% to about 60% by weight, based on the weight of the total wet filler or based on the weight of just the wet silica present.

Typically the silica (e.g., silica particles) have a silica content of at least 20 wt. %, at least 25 wt. %, at least 30 wt. %, at least 35 wt. %, at least 40 wt. %, at least 50 wt. %, at least 60 wt. %, at least 70 wt. %, at least 80 wt. %, at least 90 wt. %, or almost 100 wt. % or 100 wt. %, or from about 20 wt. % to about 100 wt. %, all based on the total weight of the particle. Any of the silica(s) can be chemically functionalized, such as to have attached or adsorbed chemical groups, such as attached or adsorbed organic groups. Any combination of silica(s) can be used. The silica can be in part or entirely a silica having a hydrophobic surface, which can be a silica that is hydrophobic or a silica that becomes hydrophobic by rendering the surface of the silica hydrophobic by treatment (e.g., chemical treatment). The hydrophobic surface may be obtained by chemically modifying the silica particle with hydrophobizing silanes without ionic groups, e.g., bis-triethoxysilylpropyltetrasulfide. Suitable hydrophobic surface-treated silica particles for use herein may be obtained from commercial sources, such as Agilon® 454 silica and Agilon® 400 silica, from PPG Industries. Silica having low surface silanol density, e.g., silica obtained through dehydroxylation at temperatures over 150° C. via, for example, a calcination process, may be used herein. An intermediate form of silica obtained from a precipitation process in a cake or paste form, without drying (a never-dried silica) may be added directly to a mixer as the wet filler, thus eliminating complex drying and other downstream processing steps used in conventional manufacture of precipitated silicas.

The carbon black can be a multi-phase aggregate comprising at least one carbon phase and at least one metal-containing species phase or silicon-containing species phase, i.e., silicon-treated carbon black. In silicon-treated carbon black, a silicon containing species, such as an oxide or carbide of silicon, is distributed through at least a portion of the carbon black aggregate as an intrinsic part of the carbon black. Silicon-treated carbon blacks are not carbon black aggregates which have been coated or otherwise modified, but actually represent dual-phase aggregate particles. One phase is carbon, which will still be present as graphitic crystallite and/or amorphous carbon, while the second phase is silica, and possibly other silicon-containing species). Thus, the silicon-containing species phase of the silicon treated carbon black is an intrinsic part of the aggregate, distributed throughout at least a portion of the aggregate. Ecoblack™ silicon-treated carbon blacks are available from Cabot Corporation. The manufacture and properties of these silicon-treated carbon blacks are described in U.S. Pat. No. 6,028,137, the disclosure of which is incorporated herein by reference.

The silicon-treated carbon black can include silicon-containing regions primarily at the aggregate surface of the carbon black, but still be part of the carbon black and/or the silicon-treated carbon black can include silicon-containing regions distributed throughout the carbon black aggregate. The silicon-treated carbon black can be oxidized. The silicon-treated carbon black can contain from about 0.1% to about 50% silicon by weight, e.g., from about 0.1% to about 46.6%, from about 0.1% to about 46%, from about 0.1% to about 45%, from about 0.1% to about 40%, from about 0.1% to about 35%, from about 0.1% to about 30%, from about 0.1% to about 25%, from about 0.1% to about 20%, from about 0.1% to about 15%, from about 0.1% to about 10%, from about 0.1% to about 5%, or from about 0.1% to about 2% by weight, based on the weight of the silicon-treated carbon black. These amounts can be from about 0.5 wt. % to about 25 wt. %, from about 1 wt. % to about 15 wt. % silicon, from about 2 wt. % to about 10 wt. %, from about 3 wt. % to about 8 wt. %, from about 4 wt. % to about 5 wt. % or to about 6 wt. %, all based on the weight of the silicon-treated carbon black.

In any embodiment and in any step, a coupling agent can be introduced in any of the steps (or in multiple steps or locations) as long as the coupling agent has an opportunity to become dispersed in the composite. The coupling agent can be or include one or more silane coupling agents, one or more zirconate coupling agents, one or more titanate coupling agents, one or more nitro coupling agents, or any combination thereof. The coupling agent can be or include bis(3-triethoxysilylpropyl)tetrasulfane (e.g., Si 69 from Evonik Industries, Struktol SCA98 from Struktol Company), bis(3-triethoxysilylpropyl)disulfane (e.g., Si 75 and Si 266 from Evonik Industries, Struktol SCA985 from Struktol Company), 3-thiocyanatopropyl-triethoxy silane (e.g., Si 264 from Evonik Industries), gamma-mercaptopropyl-trimethoxy silane (e.g., VP Si 163 from Evonik Industries, Struktol SCA989 from Struktol Company), gamma-mercaptopropyl-triethoxy silane (e.g., VP Si 263 from Evonik Industries), zirconium dineoalkanolatodi(3-mercapto) propionato-O, N,N′-bis(2-methyl-2-nitropropyl)-1,6-diaminohexane, S-(3-(triethoxysilyl)propyl) octanethioate (e.g., NXT coupling agent from Momentive, Friendly, WV), and/or coupling agents that are chemically similar or that have the one or more of the same chemical groups. Additional specific examples of coupling agents, by commercial names, include, but are not limited to, VP Si 363 from Evonik Industries, and NXTZ and NXT Z-50 silanes from Momentive. Other compounds that can function as coupling agents include those compounds having a nitroxide radical, e.g., TEMPO (2,2,6,6-tetramethyl-1-piperidinyloxy radical), as disclosed in U.S. Pat. Nos. 6,084,015, 6,194,509, 8,584,725, and U.S. Publ. No. 2009/0292044, the disclosures of which are incorporated by reference herein, or nitrile oxide, nitrile imine and nitrone 1,3-dipolar compounds, as disclosed in U.S. Pat. Nos. 10,239,971, 10,202,471, 10,787,471, and U.S. Publ. No. 2020/0362139, the disclosures of which are incorporated by reference herein. The coupling agents described herein could be used to provide hydrophobic surface modification of silica (precoupled or pretreated silica) before using it in any of the processes disclosed herein. It is to be appreciated that any combination of elastomers, additives, and additional composite may be added to the elastomer composite, for instance in a compounder.

As another option, the mixing (e.g., where the filler comprises silica and/or silicon-treated carbon black) can be performed without coupling agents. Optionally, a coating agent (filler coating agent) can be introduced in any of the steps (or in multiple steps or locations) prior to discharging. Methods of mixing without coupling agents and/or with coating agents, including exemplary coating agents, are disclosed in PCT Publication No. WO 2022/125675, the disclosure of which is incorporated by reference herein.

As an option, the wet filler can be generated in the mixer, e.g., dry filler is introduced into the mixer and wetted by adding the liquid (e.g., water, either sequentially or simultaneously or near simultaneously) to form the wet filler in the mixer, and then the solid elastomer can be added to the mixer. The introduction of dry filler to be wetted can be performed with all of the filler intended to be used or a portion thereof (e.g., wherein one or more additional portions of the wet filler are further added to the mixer to obtain the intended total amount of starting wet filler). The amount of liquid that is charged to the mixer is at least 15% by weight, or at least 20% by weight, or other amounts disclosed herein in relation to preparing a wet filler.

The charging of the mixer with at least the filler and liquid can be performed in a number of ways. In one example, the filler and liquid can be added as separate charges, e.g., the filler is added first followed by adding the liquid or vice versa. As another example, at least a portion or all of the filler and liquid can be pre-combined in an external container (e.g., a holding container, bin, table, conveyor, and the like) or another mixer and subsequently transferred or conveyed to the mixer to which the solid elastomer is charged. For example, the filler can be a blend of fillers where one type of filler (first filler) is pre-combined with a liquid (wet filler) whereas another type of filler (second filler) is charged directly to the mixer as a dry filler to produce the filler blend. Thus, the charging of the mixer with the filler and liquid includes the pre-combining of the filler and liquid prior to transferring to the mixer.

In addition to the wet filler, as an option, the mixture can further include one or more non-wetted fillers (e.g., any of the fillers that is not wetted as described herein, such as dry filler, such as a filler having no more than 10% liquid by weight.) When non-wetted filler is present, the total amount of filler can be such that at least 50% or at least 60%, at least 70%, at least 80%, at least 90%, at least 95% by weight of the total weight of filler is a wet filler, such as from 50% to 99%, from 60% to 99%, from 70% to 99%, from 80% to 99%, from 90% to 99%, or from 95% to 99% of the total amount of filler can be wet filler, with the balance of the filler being in a non-wetted state or not being considered a wet filler.

The amount of filler (e.g. wet filler alone or wet filler with other filler) that is loaded into the mixture can be targeted (on a dry weight basis) to be at least 20 phr, at least 30 phr, at least 40 phr, or range from 20 phr to 250 phr, from 20 phr to 200 phr, from 20 phr to 180 phr, from 20 phr to 150 phr, from 20 phr to 100 phr, from 20 phr to 90 phr, from 20 phr to 80 phr, 30 phr to 200 phr, from 30 phr to 180 phr, from 30 phr to 150 phr, from 30 phr to 100 phr, from 30 phr to 80 phr, from 30 phr to 70 phr, 40 phr to 200 phr, from 40 phr to 180 phr, from 40 phr to 150 phr, from 40 phr to 100 phr, from 40 phr to 80 phr, from 35 phr to 65 phr, or from 30 phr to 55 phr or other amounts within or outside of one or more of these ranges. In certain applications, a high silica loading may be desired, e.g., to further enhance wet traction performance. For example, the amount of silica loaded into the mixture (present in the composite) can be targeted to be at least 50 phr, at least 60 phr, at least 70 phr, e.g., from 50 phr to 250 phr, from 50 phr to 200 phr, from 50 phr to 150 phr, or from 50 phr to 100 phr. The above phr amounts can also apply to filler dispersed in the elastomer (filler loading). Other filler types, blends, combinations, etc. can be used, such as those disclosed in are disclosed in PCT Publ. No. WO 2020/247663, the disclosure of which is incorporated by reference herein.

In certain embodiments where the filler is electrically conductive, (e.g., carbon black), the present methods of wet-mixing with a resin can result in a rubber compound having increased electrical resistivity. This increased electrical resistivity may be an indication of improved microdispersion of fillers. For example, the electrical resistivity of rubber compounds prepared from mixing with a wet filler and solid elastomer may increase by at least 10% compared to an equivalent rubber compound (e.g., same elastomer, filler, loading, formulation) prepared from dry mixing (mixing a dry filler and solid elastomer).

With regard to the solid elastomer that is used and mixed with the wet filler, the solid elastomer can be considered a dry elastomer or substantially dry elastomer. The solid elastomer can have a liquid content (e.g., solvent or water content) of 5 wt. % or less, based on the total weight of the solid elastomer, such as 4 wt. % or less, 3 wt. % or less, 2 wt. % or less, 1 wt. % or less, or from 0.1 wt. % to 5 wt. %, 0.5 wt. % to 5 wt. %, 1 wt. % to 5 wt. %, 0.5 wt. % to 4 wt. %, and the like. The solid elastomer (e.g., the starting solid elastomer) can be entirely elastomer (with the starting liquid, e.g., water, content of 5 wt. % or less) or can be an elastomer that also includes one or more fillers and/or other components. For instance, the solid elastomer can be from 50 wt. % to 99.9 wt. % elastomer with 0.1 wt. % to 50 wt. % filler predispersed in the elastomer in which the predispersed filler is in addition to the wet filler. Such elastomers can be prepared by dry mixing processes between non-wetted filler and solid elastomers. Alternatively, a composite made by mixing a wet filler and solid elastomer (e.g., according to the processes disclosed herein) can be used as the solid elastomer and further mixed with a wet filler according to the processes disclosed herein. However, the solid elastomer is not a composite, mixture or compound made by a liquid masterbatch process and is not any other pre-blended composite of filler dispersed in an elastomer while the elastomer is in a liquid state, e.g., a latex, suspension or solution.

Any solid elastomer can be used in the present methods. Exemplary elastomers include natural rubber (NR), synthetic elastomers such as styrene butadiene rubbers (SBR, e.g., solution SBR (SSBR), emulsion SBR (ESBR), or oil-extended SSBR (OESSBR)), polybutadiene (BR), polyisoprene rubbers (IR), functionalized SBR, functionalized BR, functionalized NR, ethylene-propylene rubber (e.g., EPDM), isobutylene-based elastomers (e.g., butyl rubber), halogenated butyl rubber, polychloroprene rubber (CR), nitrile rubbers (NBR), hydrogenated nitrile rubbers (HNBR), fluoroelastomers, perfluoroelastomers, and silicone rubber, e.g., natural rubber, functionalized natural rubber, styrene-butadiene rubber, functionalized styrene-butadiene rubber, polybutadiene rubber, functionalized polybutadiene rubber, polyisoprene rubber, ethylene-propylene rubber, nitrile rubber, hydrogenated nitrile rubber, and blends thereof, or e.g., natural rubber, styrene-butadiene rubber, polybutadiene rubber, and blends thereof, e.g., a blend of first and second solid elastomers. Other synthetic polymers that can be used in the present methods (whether alone or as blends) include hydrogenated SBR, and thermoplastic block copolymers (e.g., such as those that are recyclable). Synthetic polymers include copolymers of ethylene, propylene, styrene, butadiene and isoprene. Other synthetic elastomers include those synthesized with metallocene chemistry in which the metal is selected from Ce, Pr, Nd, Sm, Gd, Tb, Dy, Ho, Tm, Yb, Lu, Co, Ni, and Ti. Polymers made from bio-based monomers can also be used, such as monomers containing modern carbon as defined by ASTM D6866, e.g., polymers made from bio-based styrene monomers disclosed in U.S. Pat. No. 9,868,853, the disclosure of which is incorporated by reference herein, or polymers made from bio-based monomers such as butadiene, isoprene, ethylene, propylene, farnesene, and comonomers thereof. If two or more elastomers are used, the two or more elastomers can be charged into the mixer as a blend at the same time (as one charge or two or more charges) or the elastomers can be added separately in any sequence and amount. For example, the solid elastomer can comprise natural rubber blended with one or more of the elastomers disclosed herein, e.g., butadiene rubber and/or styrene-butadiene rubber, or SBR blended with BR, etc. For instance, the additional solid elastomer can be added separately to the mixer and the natural rubber can be added separately to the mixer.

The solid elastomer can be or include natural rubber. If the solid elastomer is a blend, it can include at least 50 wt. % or at least 70 wt. % or at least 90 wt. % natural rubber. The blend can further comprise synthetic elastomers such as one or more of styrene-butadiene rubber, functionalized styrene-butadiene rubber, and polybutadiene rubber, and/or any other elastomers disclosed herein.

The natural rubber may also be chemically modified in some manner. For example, it may be treated to chemically or enzymatically modify or reduce various non-rubber components, or the rubber molecules themselves may be modified with various monomers or other chemical groups such as chlorine. Other examples include epoxidized natural rubber and natural rubber having a nitrogen content of at most 0.3 wt. %, as described in PCT Publ. No. WO 2017/207912.

Other exemplary elastomers include, but are not limited to, rubbers, polymers (e.g., homopolymers, copolymers and/or terpolymers) of 1,3-butadiene, styrene, isoprene, isobutylene, 2,3-dialkyl-1,3-butadiene, where alkyl may be methyl, ethyl, propyl, etc., acrylonitrile, ethylene, propylene and the like.

Other applicable solid elastomers that can be used in the presently disclosed methods are disclosed in PCT Publ. No. WO 2020/247663, the disclosure of which is incorporated by reference herein.

With regard to the mixer that can be used in any of the methods disclosed herein, any suitable mixer can be utilized that is capable of combining (e.g., mixing together or compounding together) a filler with solid elastomer. The mixer(s) can be a batch mixer or a continuous mixer. A combination of mixers and processes can be utilized in any of the methods disclosed herein, and the mixers can be used sequentially, in tandem (e.g., a tandem mixer), and/or integrated with other processing equipment. The mixer can be an internal or closed mixer or an open mixer, or an extruder or a continuous compounder or a kneading mixer or a combination thereof. The mixer can be capable of incorporating filler and resin into solid elastomer and/or capable of dispersing the filler and resin in the elastomer and/or distributing the filler and resin in the elastomer.

The mixer can have one or more rotors (at least one rotor). The at least one rotor or the one or more rotors can be screw-type rotors, intermeshing rotors, tangential rotors, kneading rotor(s), rotors used for extruders, a roll mill that imparts significant total specific energy, or a creping mill. Generally, one or more rotors are utilized in the mixer, for example, the mixer can incorporate one rotor (e.g., a screw type rotor), two, four, six, eight, or more rotors. Sets of rotors can be positioned in parallel and/or in sequential orientation within a given mixer configuration.

With regard to mixing, the mixing can be performed in one or more mixing steps. Mixing commences when at least the solid elastomer and wet filler are charged to the mixer and energy is applied to a mixing system that drives one or more rotors of the mixer. The one or more mixing steps can occur after the charging step is completed or can overlap with the charging step for any length of time. For example, a portion of one or more of the solid elastomers and/or wet filler can be charged into the mixer before or after mixing commences. The mixer can then be charged with one or more additional portions of the solid elastomer and/or filler and/or resin. For batch mixing, the charging step is completed before the mixing step is completed.

As an option, control over mixer surface temperatures, by whichever mechanism(s), can provide an opportunity for longer mixing or residence times, which can result in improved filler dispersion and/or improved rubber-filler interactions and/or consistent mixing and/or efficient mixing, compared to mixing processes without temperature control of at least one mixer surface.

The temperature-control means can be, but is not limited to, the flow or circulation of a heat transfer fluid through channels in one or more parts of the mixer. For example, the heat transfer fluid can be water or heat transfer oil. For example, the heat transfer fluid can flow through the rotors, the mixing chamber walls, the ram, and the drop door. In other embodiments, the heat transfer fluid can flow in a jacket (e.g., a jacket having fluid flow means) or coils around one or more parts of the mixer. As another option, the temperature control means (e.g., supplying heat) can be electrical elements embedded in the mixer. The system to provide temperature-control means can further include means to measure either the temperature of the heat transfer fluid or the temperature of one or more parts of the mixer. The temperature measurements can be fed to systems used to control the heating and cooling of the heat transfer fluid. For example, the desired temperature of at least one surface of the mixer can be controlled by setting the temperature of the heat transfer fluid located within channels adjacent one or more parts of the mixer, e.g., walls, doors, rotors, etc.

The temperature of the at least one temperature-control means can be set and maintained, as an example, by one or more temperature control units (“TCU”). This set temperature, or TCU temperature, is also referred to herein as “T_{z}.” In the case of temperature-control means incorporating heat transfer fluids, T_{z} is an indication of the temperature of the fluid itself.

As an option, the temperature-control means can be set to a temperature, T_{z}, ranging from 30° C. to 150° C., from 40° C. to 150° C., from 50° C. to 150° C., or from 60° C. to 150° C., e.g., from 30° C. to 155° C., from 30° C. to 125° C., from 40° C. to 125° C., from 50° C. to 125° C., from 60° C. to 125° C., from 30° C. to 110° C., from 40° C. to 110° C., from 50° C. to 110° C., 60° C. to 110° C., from 65° C. to 110° C., from 30° C. to 100° C., from 40° C. to 100° C., from 50° C. to 100° C., 60° C. to 100° C., from 65° C. to 100° C., from 30° C. to 95° C., from 40° C. to 95° C., from 50° C. to 95° C., 60° C. to 95° C., from 30° C. to 90° C., from 40° C. to 90° C., from 50° C. to 90° C., from 65° C. to 95° C., from 60° C. to 90° C., from 65° C. to 90° C., from 70° C. to 110° C., from 70° C. to 100° C., from 70° C. to 95° C., 70° C. to 90° C., from 75° C. to 110° C., from 75° C. to 100° C., from 75° C. to 95° C., or from 75° C. to 90° C. Other ranges are possible with equipment available in the art.

Compared to dry mixing, under similar situations of filler type, elastomer type, and mixer type, the present processes can allow higher energy input. Controlled removal of the water from the mixture enables longer mixing times and consequently improves the dispersion of the filler. As described herein, the present process provides operating conditions that balance longer mixing times with evaporation or removal of water in a reasonable amount of time.

Other operating parameters to be considered include the maximum pressure that can be used. Pressure affects the temperature of the filler and rubber mixture. If the mixer is a batch mixer with a ram, the pressure inside the mixer chamber can be influenced by controlling the pressure applied to the ram cylinder.

As another option, rotor tip speeds can be optimized. The energy inputted into the mixing system is a function, at least in part, of the speed of the at least one rotor and rotor type. Tip speed, which takes into account rotor diameter and rotor speed, can be calculated according to the formula:

Tip speed,m/s=π×(rotor diameter,m)×(rotational speed,rpm)/60.

As tip speeds can vary over the course of the mixing, as an option, the tip speed of at least 0.5 m/s or at least 0.6 m/s is achieved for at least 50% of the mixing time, e.g., at least 60%, at least 70%, at least 75%, at least 80%, at least 85%, at least 90%, at least 95%, or substantially all of the mixing time. The tip speed can be at least 0.6 m/s, at least 0.7 m/s, at least 0.8 m/s, at least 0.9 m/s, at least 1.0 m/s, at least 1.1 m/s, at least 1.2 m/s, at least 1.5 m/s or at least 2 m/s for at least 50% of the mixing time, or other portions of the mixing listed above. The tip speeds can be selected to minimize the mixing time, or can be from 0.6 m/s to 10 m/s, from 0.6 m/s to 8 m/s, from 0.6 to 6 m/s, from 0.6 m/s to 4 m/s, from 0.6 m/s to 3 m/s, from 0.6 m/s to 2 m/s, from 0.7 m/s to 4 m/s, from 0.7 m/s to 3 m/s, from 0.7 m/s to 2 m/s, from 0.7 m/s to 10 m/s, from 0.7 m/s to 8 m/s, from 0.7 to 6 m/s, from 1 m/s to 10 m/s, from 1 m/s to 8 m/s, from 1 m/s to 6 m/s, from 1 m/s to 4 m/s, from 1 m/s to 3 m/s, or from 1 m/s to 2 m/s, (e.g., for at least 50% of the mixing time or other mixing times described herein).

Any one or combination of commercial mixers with one or more rotors, temperature control means, and other components, and associated mixing methods to produce rubber compounds can be used in the present methods, such as those disclosed in PCT Publ. No. WO 2020/247663, the disclosure of which is incorporated by reference herein.

By “one or more mixing steps,” it is understood that the steps disclosed herein may be a first mixing step followed by further mixing steps prior to discharging. The one or more mixing steps can be a single mixing step, e.g., a one-stage or single stage mixing step or process, in which the mixing is performed under one or more of the following conditions: at least one of the mixer temperatures are controlled by temperature controlled means with one or more rotors operating at a tips speed of at least 0.6 m/s for at least 50% of mixing time, and/or the at least one temperature-control means that is set to a temperature, T_{z}, of 65° C. or higher, and/or continuous mixing; each is described in further detail herein. In certain instances, in a single stage or single mixing step the composite can be discharged with a liquid content of no more than 10% by weight. In other embodiments, two or more mixing steps or mixing stages can be performed so long as one of the mixing steps is performed under one or more of the stated conditions.

As indicated, during the one or more mixing steps, in any of the methods disclosed herein, at least some liquid present in the mixture and/or wet filler introduced is removed at least in part by evaporation. As an option, the one or more mixing steps or stages can further remove a portion of the liquid from the mixture by expression, compaction, and/or wringing, or any combinations thereof. Alternatively, a portion of the liquid can be drained from the mixer after or while the composite is discharged.

During the mixing cycle, after much of the liquid has been released from the composite and the filler incorporated, the mixture experiences an increase in temperature. It is desired to avoid excessive temperature increases that would degrade the elastomer. Discharging, (e.g., “dumping” in batch mixing), can occur on the basis of time or temperature or specific energy or power parameters selected to minimize such degradation.

In any methods disclosed herein, the discharging step from the mixer occurs and results in a composite comprising the filler dispersed in the elastomer at a total loading of at least 20 phr, at least 30 phr, at least 40 phr, at least 50 phr, e.g., from 20 to 250 phr, or other loadings disclosed herein. As an option, discharging occurs on the basis of a defined mixing time. The mixing time between the start of the mixing and discharging can be about 1 minute or more, such as from about 1 min. to 40 min., from about 1 min. to 30 min., from about 1 min. to 20 min., or from 1 min. to 15 min., or from 3 min. to 30 min., from 3 min. to 20 min., from 3 min. to 15 min., from 3 min. to 10 min., from 3 min. to 9 min., from 3 min. to 8 min., from 3 min. to 7 min., from 3 min. to 6 min., from 5 min. to 30 min., or from 5 min. to 20 min., or from 5 min. to 15 min., from 5 min. to 10 min. or from 1 min. to 12 min., or from 1 min. to 10 min. or other times. Alternatively, for batch internal mixers, ram down time can be used as a parameter to monitor batch mixing times, e.g., the time that the mixer is operated with the ram in its lowermost position e.g., fully seated position or with ram deflection (as described in PCT Publ. No. WO 2020/247663, the disclosure of which is incorporated by reference herein). Ram down time can be less than 30 min., less than 15 min., less than 10 min., less than 9 min., less than 8 min., less than 7 min., less than 6 min., or ranges from 3 min. to 30 min from 3 min. to 20 min., from 3 min. to 15 min., from 3 min. to 12 min., from 3 min. to 10 min., from 3 min. to 9 min., from 3 min. to 8 min., from 3 min. to 7 min., from 3 min. to 6 min., or from 5 min. to 15 min, or from 5 min. to 10 min. As an option, discharging occurs on the basis of dump or discharge temperature. For example, the mixer can have a dump temperature ranging from 120° C. to 190° C., 130° C. to 180° C., such as from 140° C. to 180° C., from 150° C. to 180° C., from 130° C. to 170° C., from 140° C. to 170° C., from 150° C. to 170° C., or other temperatures within or outside of these ranges.

The methods further include discharging from the mixer the composite that is formed. The discharged composite can have a liquid content of no more than 10% by weight based on the total weight of the composite, as outlined in the following equation:

Liquid content of composite %=100*[mass of liquid]/[mass of liquid+mass of dry composite]

In any of the methods disclosed herein, the discharged composite can have a liquid content of no more than 10% by weight based on total weight of the composite, such as no more than 9%, no more than 8%, no more than 7%, no more than 6%, no more than 5%, no more than 2%, or no more than 1% by weight, based on the total weight of the composite. This amount can range from 0.1% to 10%, from 0.5% to 9%, 0.5% to 7%, from 0.5% to 5%, or from 0.5% to 3% by weight, based on the total weight of the composite discharged from the mixer at the end of the process. In any of the methods disclosed herein, the liquid content (e.g., “moisture content”) can be the measured weight % of liquid present in the composite based on the total weight of the composite.

In any of the methods disclosed herein, liquid content in the composite can be the measured as weight % of liquid present in the composite based on the total weight of the composite. Any number of instruments are known in the art for measuring liquid (e.g., water) content in rubber materials, such as a coulometric Karl Fischer titration system, or a moisture balance, e.g., from Mettler (Toledo International, Inc., Columbus, OH).

In any of the methods disclosed herein, while the discharged composite can have a liquid content of 10% by weight or less, there optionally may be liquid (e.g., water) present in the mixer which is not held in the composite that is discharged. This excess liquid is not part of the composite and is not part of any liquid content calculated for the composite.

In any of the methods disclosed herein, the total liquid content (or total water content or total moisture content) of the material charged into the mixer is higher than the liquid content of the composite discharged at the end of the process. For instance, the liquid content of the composite discharged can be lower than the liquid content of the material charged into the mixer by an amount of from 10% to 99.9% (wt. % vs wt. %), from 10% to 95%, or from 10% to 50%.

Optionally the process further comprises adding the resin and optionally anti-degradants during the charging or the mixing, i.e., during the one or more mixing steps. In any embodiment disclosed herein, as another option, after the mixing of at least the solid elastomer and wet filler has commenced and prior to the discharging step, the method can further include adding the resin and optionally at least one anti-degradant to the mixer so that the resin and the at least one anti-degradant is mixed in with the solid elastomer and wet filler.

As an option, the mixture comprises, consists essentially of, or consists of the solid elastomer, the wet filler, and the resin; the mixture comprises, consists essentially of, or consists of the solid elastomer, the wet filler, the resin, and the antidegradant; the composite comprises, consists of, or consists essentially of the filler dispersed in the elastomer; the composite comprises, consists of, or consists essentially of the filler dispersed in the elastomer and the antidegradant; the composite comprises, consists of, or consists essentially of the filler and the resin dispersed in the elastomer; the composite comprises, consists of, or consists essentially of the filler and the resin dispersed in the elastomer and the antidegradant. As another option, the adding of the resin and anti-degradant(s) can occur prior to the composite being formed and having a water content of 10 wt % or less, or 5 wt % or less.

The adding of the resin and optional adding of the anti-degradant(s) can occur at any time prior to the discharging step, e.g., before or after the mixer reaches an indicated mixer temperature of 120° C. or higher. This indicated mixer temperature can be measured by a temperature-measuring device within the mixing cavity. The indicated temperature of the mixer can be the same as or differ by 30° C. or less, or 20° C. or less, or 10° C. or less (or 5° C. or less or 3° C. or less or 2° C. or less) from the maximum temperature of the mixture or the composite achieved during the mixing stage (which can be determined by removing the composite from the mixer and inserting a thermocouple or other temperature measuring device into the composite). In this mixing method, as an option, the resin and optionally the antidegradant can be added to the mixer when the mixer reaches the temperature of 120° C. or higher. In other embodiments, the indicated temperature can range from 120° C. to 190° C., from 125° C. to 190° C., from 130° C. to 190° C., from 135° C. to 190° C., from 140° C. to 190° C., from 145° C. to 190° C., from 150° C. to 190° C., from 120° C. to 180° C., from 125° C. to 180° C., from 130° C. to 180° C., from 135° C. to 180° C., from 140° C. to 180° C., from 145° C. to 180° C., from 150° C. to 180° C., from 120° C. to 170° C., from 125° C. to 170° C., from 130° C. to 170° C., from 135° C. to 170° C., from 140° C. to 170° C., from 145° C. to 170° C., from 150° C. to 170° C., and the like.

Examples of an anti-degradant that can be introduced is N-(1,3-dimethylbutyl)-N′-phenyl-p-phenylenediamine (6PPD), and others are described in other sections herein. The anti-degradant can be introduced in an amount ranging from 1% to 5%, from 0.5% to 2%, or from 0% to 3% by weight based on the weight of the composite that is formed. Anti-degradants added during the charging step or the mixing step may help prevent elastomer degradation during the mixing; however, due to the presence of the water in the mixture, the rate of degradation of the elastomer is lower compared to dry mix processes and the addition of anti-degradant can be delayed.

After the composite is formed and discharged, the method can include the further optional step of mixing the composite with additional elastomer to form a composite comprising a blend of elastomers. The “additional elastomer” or second elastomer can be additional natural rubber or can be an elastomer that is not natural rubber such as any elastomer disclosed herein, e.g., synthetic elastomers (e.g. styrene butadiene rubbers (SBR such as SSBR, ESBR, etc.), polybutadiene (BR) and polyisoprene rubbers (IR), ethylene-propylene rubber (e.g., EPDM), isobutylene-based elastomers (e.g., butyl rubber), polychloroprene rubber (CR), nitrile rubbers (NBR), hydrogenated nitrile rubbers (HNBR), polysulfide rubbers, polyacrylate elastomers, fluoroelastomers, perfluoroelastomers, and silicone elastomers). Blends of two or more types of elastomers (blends of first and second elastomers), including blends of synthetic and natural rubbers or with two or more types of synthetic or natural rubber, may be used as well.

The mixer can be charged with two or more charges of different elastomer to form a composite blend. For example, the mixer can be charged with the never-dried natural rubber and at least one additional elastomer, where the at least one additional elastomer is also a coagulum or a solid elastomer (e.g., having less than 5% water). Alternatively, the mixer can be charged with an elastomer blend. As another option, the process can comprise mixing the discharged composite with additional elastomer to form the blend. The composite discharged (e.g., after single-stage or two or multi-stage mixing) can have a moisture content of no greater than 5%, 3%, 2% by weight relative to the weight of the composite when blending with one or more additional elastomers (e.g., a composite comprising filler (e.g., carbon black, silica, and/or silicon-treated carbon black) and natural rubber can be blended with synthetic elastomers such as BR or SBR). Further, both elastomers and fillers (wet or dry, such as wet or dry carbon black and/or silica and/or silicon-treated carbon black) can be combined with the composite.

As another option, a composite comprising a filler (e.g., carbon black and/or silica and/or silicon-treated carbon black) and natural rubber prepared according to the presently disclosed methods can be combined with a masterbatch containing natural rubber and/or synthetic polymers made by any method known in the art, such as by known dry mixing or solvent masterbatch processes. For example, silica/elastomer masterbatches can be prepared as described in U.S. Pat. Nos. 9,758,627 and 10,125,229, or masterbatches from neodymium-catalyzed polybutadienes as described in U.S. Pat. No. 9,758,646, the disclosures of which are incorporated by reference herein. The masterbatch can have a fibrous filler, such as poly(p-phenylene terephthalamide) pulp, as described in U.S. Pat. No. 6,068,922, the disclosure of which is incorporated by reference herein. Masterbatches can have fillers such as graphenes, graphene oxides, reduced graphene oxides, or densified reduced graphene oxide granules, carbon nanotubes, single-wall carbon nanotubes, multi-wall carbon nanotubes, and carbon nanostructures, in which masterbatches of the latter are disclosed in U.S. Pat. No. 9,447,259, and PCT Appl. No. PCT/US2021/027814, the disclosures of which are incorporated by reference herein. Other suitable masterbatches can include the composites prepared from mixing wet filler and solid elastomer, as described in PCT Publ. No. WO 2020/247663, the disclosure of which is incorporated by reference herein. For example, the masterbatch can have a filler such as carbon black and/or silica and an elastomer such as SBR and/or butadiene rubber. Commercially available masterbatches can also be used, e.g., commercially available masterbatches such as Emulsil™ silica masterbatch or Emulblack™ carbon black masterbatch (both available from Dynasol group).

Exemplary masterbatches comprising elastomer blends include: blends of natural rubber with synthetic, bio-sourced, and/or functionalized elastomers (e.g., SSBR, ESBR, BR) where the filler can be selected from one or more of carbon black, silica, and silicon-treated carbon black.

In addition to the solid elastomer, wet filler, and resin, the mixer can be charged with one or more charges of at least one additional elastomer to form a composite blend. As another option, the process can comprise mixing the discharged composite with additional elastomer to form the blend. The at least one additional elastomer can be the same as the solid elastomer or different from the solid elastomer.

Alternatively, the composite when discharged may contain at least one additive selected from antidegradants and coupling agents (e.g., where the wet filler further comprises silica, or where dry silica is charged to the mixer), which can be added at any time during the charging or mixing.

For multi-stage process, the methods for preparing the composite include the step of charging or introducing into a first mixer at least a) one or more solid elastomers, b) one or more fillers wherein at least one filler or a portion of at least one filler is wet filler as described herein (e.g. a wet filler that comprises a filler and a liquid present in an amount of at least 15% by weight based on the total weight of the wet filler), and optionally, c) the resin. The combining of the solid elastomer with wet filler and optionally the resin forms a mixture or composite during this mixing step(s), which can be considered as a first mixing step or stage. The method further includes mixing the mixture, in this first mixing step, to an extent that at least a portion of the liquid is removed by evaporation or an evaporation process that occurs during the mixing. This first mixing step (in one or more mixing steps) or stage is conducted using one or more of the processes described earlier that forms a composite with the understanding that, after completion of the first mixing, it is not necessary for the mixture discharged from the mixer after the first mixing step (e.g., a discharged mixture) to have a liquid content of no more than 10 wt. %. In other words, with the multi-stage process(es), the mixture resulting from the completion of the first mixing from the first mixer (or first mixing step) can have a liquid content above 10 wt. %, but does have a liquid content that is reduced (by wt. %) as compared to the liquid content of the combined solid elastomer and wet filler at the start of the first mixing step.

Before the first mixer or other mixer is used in the second mixing step, as a further option, there can be a standing time wherein the composite formed from the first mixing rests or cools or both in the first mixer or in another container or location (e.g., mixing, stopping, and then mixing further). For instance, this standing time can be such that the mixture obtains a material temperature (also referred to as probe temperature) of less than 180° C. before the further mixing step commences (e.g., the discharged mixture can have a material temperature ranging from about 100° C. to about 180° C., of from about 70° C. to 179° C., or from about 100° C. to about 170° C., or from about 120° C. to about 160° C.). Or, the standing time before the further or second mixing step commences, can be from about 1 minute to 60 minutes or more. The material temperature can be obtained by a number of methods known in the art, e.g., by inserting a thermocouple or other temperature measuring device into the mixture or composite.

The method then includes mixing or further mixing the mixture in at least a second mixing step or stage utilizing the same mixer (i.e., the first mixer) and/or utilizing a second mixer(s) that is different from the first mixer. With a multi-stage mixing process, there is the option of charging the resin to either the first mixer, the second mixer, or both.

After the first mixing, the further mixing step(s) conducted for the multi-stage mixing can utilize any one or more of the mixing procedures or parameters or steps utilized in the first mixing step as described herein. Thus, in conducting the further mixing step or stage, the same or different mixer design and/or same or different operating parameters as for the first mixer can be used in the further mixing stage. The mixers and their options described earlier for the first mixing step and/or the operating parameters described earlier for the mixing step can be optionally used in the further or second mixing step (e.g. the mixing steps, as described herein, that include a tip speed of at least 0.5 m/s for at least 50% of the time or at least 0.6 m/s for at least 50% of the time, and/or a T_{z} of 65° C. or higher, among other parameters disclosed herein or in PCT Publ. No. WO 2020/247663, the disclosure of which is incorporated by reference herein.

In the multi-stage processes, a second mixing step (second stage mix) can also comprise charging the mixer with other components in addition to the mixture discharged from the first mixing step. For example, where the resin is not charged to the first mixer, the resin can be charged to the second mixer, e.g., as a separate charge, or as a mixture (particulate mixture or co-pellet) with filler (wet or dry filler, same or different filler as charged to the first mixer). Additionally or alternatively, as an example, the method can comprise charging additional filler, such as dry filler, wet filler, or a blend thereof prior to or during the second mixing step. The additional filler can be the same or different from the filler already present in the mixture. For example, the mixture discharged from the first mixer can be considered a masterbatch in which either all or a portion is combined with additional filler. For example, wet or dry carbon black, silica, silicon-treated carbon black (and blends thereof) can be added to the mixture discharged from the first mixing step, such as a mixture comprising carbon black and natural rubber.

For the multi-stage mixing process(es), in at least one option, at least a second mixer is used in the further mixing step(s). When this option is used, the second mixer can have the same or different design as the first mixer, and/or can have the same or one or more different operating parameters as the first mixer. Specific examples, not meant to be limiting, are provided below with respect to first mixer and second mixer options. For instance, the first mixer can be a tangential mixer or an intermesh mixer, and the second mixer can be a tangential mixer, an intermesh mixer, an extruder, a kneader, or a roll mill. For instance, the first mixer can be an internal mixer and the second mixer can be a kneader, a single screw extruder, a twin-screw extruder, a multiple-screw extruder, a continuous compounder, or a roll mill. For instance, the first mixer can be a first tangential mixer, and the second mixer can be a second (different) tangential mixer. For instance, the first mixer is operated with a ram, and the second mixer is operated without a ram. For instance, the second mixer is utilized and is operated at a fill factor of the mixture, on a dry weight basis, ranging from 25% to 70%, from 25% to 60%, from 25% to 50%, from 30% to 50%, or other fill factor amounts described herein.

As an option, the method includes mixing or further mixing the mixture in at least a second mixing step or stage utilizing the same mixer (i.e., the first mixer) and/or utilizing a second mixer(s) that is different from the first mixer. The mixing with the second mixer can be such that the second mixer or second mixing is operated under at least one of the following conditions: (i) a ram pressure of 5 psi or less and/or (ii) with the ram raised to at least 75% of the ram's highest level (such as at least 85%, at least 90%, at least 95%, or at least 99% or 100% of the ram's highest level), and/or (iii) a ram operated in floating mode, and/or (iv) a ram positioned such that it does not substantially contact the mixture; and/or (v) a ram-less mixer; and/or (vi) a fill factor of the mixture ranges from 25% to 70%. As an option, the second mixer can be operated at a fill factor of the mixture, on a dry weight basis, ranging from 25% to 70%, from 25% to 60%, from 25% to 50%, or from 30% to 50%. As an option, the mixing with the second mixer can be performed under at least one of the following conditions (i) to (vi) for anywhere from 0% to 100% of the mixing time, e.g., from 10% to 100%, from 20% to 100%, from 30% to 100%, from 40% to 100%, or the second mixer is operated under at least one of the following conditions (i) to (vi) for at least 50% of the mixing time, e.g., from 50% to 100%, from 60% to 100%, from 70% to 100%, from 80% to 100%, or from 90% to 100% of the mixing time.

The method then includes discharging from the last used mixer the composite that is formed such that the composite has a liquid content of no more than 10% by weight based on the total weight of the composite. Methods for operating a second mixer that are suitable are described in PCT Publ. No. WO 2020/247663, the disclosure of which is incorporated by reference herein.

The composites prepared by any of the methods disclosed herein can consist of natural rubber and filler, i.e., no rubber chemicals are present. Alternatively, in addition to filler and natural rubber, the composite can comprise at least one additive selected from anti-degradants and coupling agents. Alternatively, the composites can include one or more rubber chemicals. In another alternative, the composite can be curative-bearing compositions.

Additives can also be incorporated in mixing and/or compounding steps (e.g., whether in a single-stage mix, or the second stage or third stage of a multi-stage mix); typical additives include anti-degradants, coupling agents, and one or more rubber chemicals to enable dispersion of filler into the elastomer. Rubber chemicals, as defined herein, include one or more of: processing aids (to provide ease in rubber mixing and processing, e.g. various oils and plasticizers, wax), activators (to activate the vulcanization process, e.g. zinc oxide and fatty acids), accelerators (to accelerate the vulcanization process, e.g. sulphenamides and thiazoles), vulcanizing agents (or curatives, to crosslink rubbers, e.g. sulfur, peroxides), and other rubber additives, such as, but not limited to, retarders, co-agents, peptizers, adhesion promoters (e.g., use of cobalt salts to promote adhesion of steel cord to rubber-based elastomers, e.g., as described in U.S. Pat. No. 5,221,559 and U.S. Pat. Publ. No. 2020/0361242, the disclosures of which are incorporated by reference herein), resins (e.g., tackifiers, traction resins), flame retardants, colorants, blowing agents, additives to reduce heat build-up (HBU), and linking agents such as those described in U.S. Prov. Appl. No. 63/123,386, the disclosure of which is incorporated by reference herein. As an option, the rubber chemicals can comprise processing aids and activators. As another option, the one or more other rubber chemicals are selected from zinc oxide, fatty acids, zinc salts of fatty acids, wax, accelerators, resins, and processing oil.

In any method of producing a composite disclosed herein, the method can further include one or more of the following steps, after formation of the composite:
one or more holding steps;
one or more drying steps can be used to further dry the composite to obtain a dried composite;
one or more extruding steps;
one or more calendaring steps;
one or more milling steps to obtain a milled composite;
one or more granulating steps;
one or more cutting steps;
one or more baling steps to obtain a baled product or mixture;
the baled mixture or product can be broken apart to form a granulated mixture; and/or
one or more mixing or compounding steps; and/or
one or more sheeting steps.

As a further example, the following sequence of steps can occur and each step can be repeated any number of times (with the same or different settings), after formation of the composite:
one or more holding steps to develop further elasticity
one or more cooling steps
drying the composite further to obtain a further dried composite;
mixing or compounding the composite to obtain a compounded mixture;
milling the compounded mixture to obtain a milled mixture (e.g., roll milling);
granulating the milled mixture;
optionally baling the mixture after the granulating to obtain a baled mixture;
optionally breaking apart the baled mixture and mixing.

In addition, or alternatively, the composite can be compounded with one or more antidegradants, zinc oxide, fatty acids, zinc salts of fatty acids, wax, accelerators, resins, processing oil, and/or curing agents, and vulcanized to form a vulcanizate. Such vulcanized compounds can have one or more improved properties, such as one or more improved rubber properties, such as, but not limited to, an improved hysteresis, wear resistance and/or rolling resistance, e.g., in tires, or improved mechanical and/or tensile strength, or an improved tan delta and/or an improved tensile stress ratio, and the like.

As an example, in a compounding step, the ingredients, with the exception of the sulfur or other cross-linking agents and accelerator, are combined with the neat composite in a mixing apparatus (the non-curatives and/or antidegradants, are often pre-mixed and collectively termed “smalls”). The most common mixing apparatus is the internal mixer, e.g., the Banbury or Brabender mixer, but other mixers, such as continuous mixers (e.g., extruders), may also be employed. Thereafter, in a latter or second compounding step, the cross-linking agent, e.g., sulfur, and accelerator (if necessary) (collectively termed curatives) are added. As another option, the compounding can comprise combining the composite with one or more of antidegradants, zinc oxide, fatty acids, zinc salts of fatty acids, wax, accelerators, resins, processing oil, and curing agents in a single compounding stage or step, e.g., the curatives can be added with smalls in the same compounding stage. The compounding step is frequently performed in the same type of apparatus as the mixing step but may be performed on a different type of mixer or extruder or on a roll mill. One of skill in the art will recognize that, once the curatives have been added, vulcanization will commence once the proper activation conditions for the cross-linking agent are achieved. Thus, where sulfur is used, the temperature during mixing is preferably maintained substantially below the cure temperature.

Also disclosed herein are methods of making a vulcanizate. The method can include the steps of at least curing a composite in the presence of at least one curing agent. Curing can be accomplished by applying heat, pressure, or both, as known in the art.

With respect to this vulcanizate, the vulcanizate can have one or more elastomeric properties. For instance, a vulcanizate containing silica can have a tensile stress ratio M300/M100 of at least 4.3, least 4.5, at least 5.0, or ranging from 4.3 to 5.5. A vulcanizate comprising carbon black can have a tensile stress ratio M300/M100 of at least 5.9, e, g., at least 6.0, at least 6.1, at least 6.2, as evaluated by ASTM D412, wherein M100 and M300 refer to the tensile stress at 100% and 300% elongation, respectively.

Alternatively or in addition, the vulcanizate can have a maximum tan δ (60° C.) of no greater than 0.22, e.g., no greater than 0.21, no greater than 0.2, no greater than 0.19, no greater than 0.18, e.g., no greater than 0.16, no greater than 0.15, no greater than 0.14, no greater than 0.13, no greater than 0.12, or no greater than 0.11.

The vulcanizates prepared from the present composites (e.g., those made by any of the presently disclosed processes of mixing wet filler, solid elastomer, and resin under the disclosed mixing conditions of T_{z} or tip speed, whether single stage or multi-stage) can show improved properties. For example, vulcanizates prepared from the present composites can have improved properties over a vulcanizate prepared from a composite made by dry mixing solid elastomer, non-wetted filler, and resin (“dry mix composite”), particularly those dry mix composites having the same composition (“dry mix equivalent”). Thus, the comparison is made between dry mixes and the present mixing processes between comparable fillers, elastomers, filler loading (e.g., ±5 wt %, 2 wt. %), and compound formulation (including resin), and optionally curing additives. Under these conditions, the vulcanizate has a tan δ value that is less than a tan δ value of a vulcanizate prepared from a dry mix composite having the same composition. In addition to or in the alternative, the vulcanizate has a tensile stress ratio, M300/M100, that is greater than a tensile stress ratio of a vulcanizate prepared from a dry mix composite having the same composition, wherein M100 and M300 refer to the tensile stress at 100% and 300% elongation, respectively.

Also disclosed herein are articles made from or containing the composite or vulcanizates disclosed herein.

The composite may be used to produce an elastomer or rubber containing product. As an option, the elastomer composite may be used in or produced for use, e.g., to form a vulcanizate to be incorporated in various parts of a tire, for example, tire treads (such as on road or off-road tire treads), including cap and base, undertread, innerliners, tire sidewalls, tire carcasses, tire sidewall inserts, wire-skim for tires, and cushion gum for retread tires, in pneumatic tires as well as non-pneumatic or solid tires. Alternatively or in addition, elastomer composite (and subsequently vulcanizate) may be used for hoses, seals, gaskets, weather stripping, windshield wipers, automotive components, liners, pads, housings, wheel and track elements, tire sidewall inserts, wire-skim for tires, and cushion gum for retread tires, in pneumatic tires as well as non-pneumatic or solid tires. Alternatively or in addition, elastomer composite (and subsequently vulcanizate) may be used for hoses, seals, gaskets, anti-vibration articles, tracks, track pads for track-propelled equipment such as bulldozers, etc., engine mounts, earthquake stabilizers, mining equipment such as screens, mining equipment linings, conveyor belts, chute liners, slurry pump liners, mud pump components such as impellers, valve seats, valve bodies, piston hubs, piston rods, plungers, impellers for various applications such as mixing slurries and slurry pump impellers, grinding mill liners, cyclones and hydrocyclones, expansion joints, marine equipment such as linings for pumps (e.g., dredge pumps and outboard motor pumps), hoses (e.g., dredging hoses and outboard motor hoses), and other marine equipment, shaft seals for marine, oil, aerospace, and other applications, propeller shafts, linings for piping to convey, e.g., oil sands and/or tar sands, and other applications where abrasion resistance and/or enhanced dynamic properties are desired. Further the elastomer composite, via the vulcanized elastomer composite, may be used in rollers, cams, shafts, pipes, bushings for vehicles, or other applications where abrasion resistance and/or enhanced dynamic properties are desired.

Accordingly, articles include vehicle tire treads including cap and base, sidewalls, undertreads, innerliners, wire skim components, tire carcasses, engine mounts, bushings, conveyor belt, anti-vibration devices, weather stripping, windshield wipers, automotive components, seals, gaskets, hoses, liners, pads, housings, and wheel or track elements. For example, the article can be a multi-component tread, as disclosed in U.S. Pat. Nos. 9,713,541, 9,713,542, 9,718,313, and 10,308,073, the disclosures of which are incorporated herein by reference.

For example, rubber compounds (vulcanizates) derived from the composites disclosed herein (composites prepared by the methods disclosed herein) can be used for truck tread or passenger and light truck (PC/LT) treads, e.g., treads for electric vehicles (EVs). For example, the elastomer in the rubber compound (or composite) can be SBR (e.g., SSBR, functionalized SBR, etc.), or a blend of SBR and BR and the filler can be silica or a silica/carbon black blend. For example, the filler can be primarily silica, e.g., at least 50% silica, at least 75% silica, at least 90% silica, at least 95% silica by weight, relative to the total weight of the filler (dry basis) with the remainder carbon black. As another example, the elastomer can be natural rubber and the filler can be silica or a silica/carbon black blend as disclosed herein. The silica can have a loading of at least 20 phr, as disclosed herein, or can have higher loadings, e.g., at least 50 phr as disclosed herein (e.g., at least 60 phr, at least 70 phr, etc.). Epoxidized, purified natural rubber, and polyisoprene can be used in combination with silica and resins in the wet mixing process to prepare rubber compositions for passenger and light truck tire tread applications. The resins can be selected to improve wet traction and optionally steering ability. For example, where the rubber compound comprises natural rubber and silica (and optionally a minor amount of carbon black), the resin can be a C5 resin. As another example, where the rubber compound comprises SBR (e.g., functionalized SBR) and silica (and optionally a minor amount of carbon black), the resin can be a C9 resin. As another example, where the rubber compound comprises a blend of SBR/BR and silica (and optionally a minor amount of carbon black), the resin can be a C5/C9 resin.

### EXAMPLES

The Examples describe the preparation of elastomer composites and corresponding vulcanizates from various elastomers and fillers.

All mixing and compounding were performed with a BR-1600 Banbury® mixer (“BR1600”; Manufacturer: Farrel) operating with 2-wing, tangential rotors (2WL), providing a capacity of 1.6 L.

Water content in the discharged composite was measured using a moisture balance (Model: HE53, Manufacturer: Mettler Toledo NA, Ohio). The composite was sliced into small pieces (size: length, width, height<5 mm) and 2 to 2.5 g of material was placed on a disposable aluminum disc/plate which was placed inside the moisture balance. Weight loss was recorded for 30 mins at 125° C. At the end of 30 mins, moisture content for the composite was recorded as:

moisture content of composite=(initial weight−final weight/initial weight)*100.

Small amounts of organic volatile content (<0.1 wt %) may be included in the moisture test values.

The following tests were used to obtain performance data on each of the vulcanizates:
Tensile stress at 100% elongation (M100) and tensile stress at 300% elongation (M300) were evaluated by ASTM D412 (Test Method A, Die C) at 23° C., 50% relative humidity and at crosshead speed of 500 mm/min. Extensometers were used to measure tensile strain. The ratio of M300/M100 is referred to as tensile stress ratio (or modulus ratio).
Max tan δ was measured with an ARES-G2 rheometer (Manufacturer: TA Instruments) using 8 mm diameter parallel plate geometry in torsional mode. The vulcanizate specimen diameter size was 8 mm diameter and about 2 mm in thickness. The rheometer was operated at a constant temperature of 60° C. and at constant frequency of 10 Hz. Strain sweeps were run from 0.1-68% strain amplitude. Measurements were taken at ten points per decade and the maximum measured tan δ (“max tan δ”) was reported, also referred to as “tan δ” unless specified otherwise. The max G″ Tg was measured with the same instrument using 8 mm diameter parallel plate geometry in torsional mode. The vulcanizate specimen diameter size was 8 mm diameter and about 2 mm in thickness. The rheometer was operated at constant frequency of 10 Hz. Temperature sweeps were run from 80 to −110° C. The temperature at the maximum value of G″ was reported as max G″ Tg.
Die B tear strength was measured by ASTM D624 at 23° C. using a nicked specimen pulled at 500 mm/min. from a tensile test machine. The maximum force required to tear the test specimen is used to calculate the tear strength
Volume resistivity (Ohm·cm) measurements were conducted on 2 mm thick rubber plaques cut from sheets with a 2″×5″ resistivity die. Both ends of the sheet (˜5″ apart) were painted with Conductive Silver Paint 187 (Electron Microscopy Sciences) on both sides of the plaque and dried overnight. Resistivity clamps were attached to the painted edges and voltage was measured with a Wavetek® meter. For resistance readings beyond 2000 M Ohms, measurements were conducted with a Dr. Kamphausen Milli-TO 2 meter.

### Example 1

This Example describes the preparation of composites, and corresponding vulcanizates, comprising elastomer, silica, and resin. Composites were prepared by dry mixing methods and wet mixing methods in which a solid elastomer was mixed with a wet filler. Each mixing method was performed with and without resin.

The elastomers used were functionalized solution SBR (HPR950, JSR Corp), butadiene rubber (“BR”; BUNA® CB 24 butadiene rubber, Lanxess, Germany), and natural rubber (RSS3 “NR”, Hokson Rubber, Malaysia). The silica used was ZEOSIL® Z1165 MP precipitated silica from Solvay USA Inc., Cranbury, N.J. The coupling agent was Si-69 silane coupling agent (“Si69”; Evonik Industries). The silane coupling agent was added together with the first portion of silica. Dry silica with a moisture content of 7.5 wt. % moisture was fed at a rate of 460 lbs/hr to a continuous FEECO pin mixer. Water was sprayed using two fan nozzles in the pin mixer located just after where the dry silica entered the pin mixer. The water spray rate was 486 lbs/hr. Uniform wet silica pellets between 60 and 120 mesh were discharged with 53 wt. % water. Properties of the elastomers are shown in Table 1.

TABLE 1

| | | | | Mooney | |
|---|---|---|---|---|---|
| | Styrene | vinyl | cis 1,4 | Viscosity, | Polymer |
| Elastomer | content | content | content | ML(1 + 4) at | Tg |
| Grade | (%) | (%) | (%) | 100° C. | (° C.) |
| fSSBR - | 28 | 59 | | 75 | −27 |
| HPR950 | | | | | |
| Natural | | | | N/A | −63 |
| Rubber - RSS3 | | | | | |
| High cis BR - | | | 96 | 44 | −106 |
| Buna CB24 | | | | | |

Resins used were Impera™ R1607 resin (“R1607”), Impera™ D1606 resin (“D1606”), Impera™ G1750 resin (“G1750”), and Permalyn™ 5095 resin (“5095”), all from Eastman Chemical Co. Properties of the resins are shown in Table 2 below.

TABLE 2

| | Resin | Resin Tg, | Ring and Ball Softening |
|---|---|---|---|
| Resin Grade | Type | ° C. | Point, ° C. |
| R1607 | C5 | 46 | 100 |
| D1606 | C5/C9 | 40 | 90 |
| G1750 | C9 | 50 | 100 |
| 5095 | Rosin | 45 | 88 |

An f-SSBR/BR blend of a 70/30 ratio and with silica loadings (50 to 70 phr) with or without resins were included as PC or light truck tread references. Natural rubber/silica compositions, with varied silica (50 to 70 phr, all dry-based) and resin (0, 13 and 25 phr) loadings were prepared at equal compound Shore A hardness via conventional dry mixing, as comparisons for rubber compositions from the wet mix process. The silane coupling agent loading of 10 wt. % of the silica loading was used for all compounds. Carbon black (CB) at 4 phr loading (ASTM grade N134, provided as VULCAN® 10H carbon black) was also present in each rubber compound.

A three-stage mixing protocol was followed to prepare the SBR/BR and NR dry mix reference and comparison compounds. Stage 1 mixing protocols for the reference and comparison compounds and for the experimental compounds are shown in Table 3 and Table 4, respectively. A TCU temperature of 80° C., a rotor speed of 70 rpm, and a fill factor of 70% were applied in the stage 1 dry mixing whereas a TCU temperature of 90° C., a rotor speed of 100 rpm, and fill factor of 70% in stage 1 were applied for wet mixing. For the dry mix process, ZnO (3 phr), stearic acid (2 phr), 6PPD (1.5 phr), TMQ (1.5 phr), and wax (1.5 phr) were added with the coupling agent and resin (if any) during the first stage mixing, as indicated in Table 3. The time intervals refer to the time period from the start of the mixing, defined as “0 s.” After stage 1 mixing, the water content of the composites was less than 2.0 wt. %.

TABLE 3

| | Temp | |
|---|---|---|
| Time (s) | (° C.) | Description |
| 0 | 80 | add polymer |
| 30 | | Add ⅔ silica, CB, coupling agent, resin (if any) |
| 90 | | add remaining silica |
| 120 | | sweep |
| 180 | | add ZnO, stearic acid, 6 PPD, TMQ, wax |
| 240 | | scrape/sweep |
| 300 | 160 | dump at 300 s and adjust rpm to achieve |
| | | temp <160° C. if needed |

TABLE 4

| | Temp | |
|---|---|---|
| Time (s) | (° C.) | Description |
| 0 | 90 | add polymer |
| 30 | | add ¾ silica, CB, coupling agent, resin (if any) |
| 150 | 125 | sweep and add remaining silica at 150 s or 125° C. |
| 190 | | sweep |
| | 150 | add 6 PPD |
| | 155 | scrape/sweep |
| | 160 | dump |

The same second and third stage protocols were used to prepare both dry and wet mixed rubber compounds (Tables 5 and 6, respectively), with the exception that for the wet mixed composite, ZnO (3 phr), stearic acid (2 phr), 6PPD (1.5 phr), TMQ (1.5 phr), and wax (1.5 phr) were added during second stage mixing as indicated in Table 5. Stage 2 conditions were: TCU temp=50° C.; rotor speed=80 rpm; ramp pressure=2.8 bar; Fill factor=68%. Stage 3 conditions were: TCU temp=50° C.; rotor speed=60 rpm; ramp pressure=2.8 bar; Fill factor=65%. For the final stage mixing, curatives (sulfur and TBBS) were added where the TBBS level was adjusted based on the silica loading in the compound formulation (see Tables 7-10 for actual amounts added).

TABLE 5

| Time (s) | Description |
|---|---|
| 0 | add stage 1 composite |
| 30 | add ZnO, stearic acid, 6 PPD, TMQ, wax (for |
| | wet mix composites) |
| 90 | scrape/sweep |
| 180 | dump at 180 s and adjust rpm to achieve temp <150° C. |

TABLE 6

| Time (s) | Description |
|---|---|
| 0 | add ½ stage 2 composite/curatives/remaining composite |
| 30 | sweep |
| 90 | dump, adjust rpm to achieve temp <110° C. |

After the final stage, the composites were sheeted on a 2-roll mill operated at 50° C. and about 22 rpm, followed by six pass-throughs with a nip gap about 5 mm. The final compounds were sheeted to 2.4 mm thickness on a 2-roll mill operated at 50° C. The final compounds were cured in a heated press (2500 lbs) at 150° C. for 30 min.

Tables 7-10 shows properties of cured rubber compounds containing C5, C5/C9, C9, and rosin resins, respectively, along with the comparative samples in which the composites were prepared by dry mixing with and without resin or by wet mixing without resin. “OL” refers to over the load cell limit, indicating the compound was too rigid.

TABLE 7

| | 1 | 2 | 3 | 4 | 5 | 6 | 7 | 8 | 9 |
|---|---|---|---|---|---|---|---|---|---|
| Ingredient | | | | | | | | | |
| fSSBR HPR950 | 70 | 70 | 70 | | | | | | |
| BR CB24 | 30 | 30 | 30 | | | | | | |
| RSS3 | | | | 100 | 100 | 100 | 100 | 100 | 100 |
| C5 resin | | | | 0 | 13 | 25 | 0 | 13 | 25 |
| C9 resin | 0 | 13 | 25 | | | | | | |
| dry silica pellets | 50 | 60 | 70 | 50 | 60 | 70 | | | |
| wet silica pellets | | | | | | | 50 | 60 | 70 |
| N134 carbon black | 4 | 4 | 4 | 4 | 4 | 4 | 4 | 4 | 4 |
| Si69 coupling agent | 5 | 6 | 7 | 5 | 6 | 7 | 5 | 6 | 7 |
| TBBS | 2.0 | 2.1 | 2.2 | 2.0 | 2.1 | 2.2 | 2.0 | 2.1 | 2.2 |
| sulfur | 1.6 | 1.6 | 1.6 | 1.6 | 1.6 | 1.6 | 1.6 | 1.6 | 1.6 |
| Properties | | | | | | | | | |
| M100 at 60° C., MPa | 3.2 | 2.5 | 2.2 | 2.7 | 2.3 | 2.0 | 3.0 | 2.4 | 1.9 |
| M300 at 60° C., MPa | 11.8 | 9.1 | 7.9 | 10.6 | 8.8 | 7.1 | 13.3 | 11.2 | 8.6 |
| M300/M100 at 60° C. | 3.7 | 3.7 | 3.6 | 3.9 | 3.8 | 3.5 | 4.5 | 4.6 | 4.4 |
| Die B Tear Strength at | 49 | 55 | 61 | 142 | 144 | 101 | 123 | 129 | 113 |
| 23° C., KNm | | | | | | | | | |
| tan δ max at 60° C. - | 0.092 | 0.129 | 0.161 | 0.139 | 0.190 | 0.233 | 0.082 | 0.117 | 0.174 |
| Strain Sweep | | | | | | | | | |
| G″ Tg, ° C. - Temp. Sweep | −51.3 | −41.9 | OL | −54.0 | −51.4 | −48.9 | −54.2 | −50.7 | −48.9 |

TABLE 8

| | 1 | 2 | 3 | 4 | 11 | 12 | 7 | 14 | 15 |
|---|---|---|---|---|---|---|---|---|---|
| Ingredient | | | | | | | | | |
| fSSBR HPR950 | 70 | 70 | 70 | | | | | | |
| BR | 30 | 30 | 30 | | | | | | |
| NR | | | | 100 | 100 | 100 | 100 | 100 | 100 |
| C5/C9 resin | | | | 0 | 13 | 25 | 0 | 13 | 25 |
| C9 resin | 0 | 13 | 25 | | | | | | |
| dry silica pellets | 50 | 60 | 70 | 50 | 60 | 70 | | | |
| wet silica pellets | | | | | | | 50 | 60 | 70 |
| N134 carbon black | 4.0 | 4.0 | 4.0 | 4.0 | 4.0 | 4.0 | 4.0 | 4.0 | 4.0 |
| Si69 coupling agent | 5.0 | 6.0 | 7.0 | 5.0 | 6.0 | 7.0 | 5.0 | 6.0 | 7.0 |
| TBBS | 2.0 | 2.1 | 2.2 | 2.0 | 2.1 | 2.2 | 2.0 | 2.1 | 2.2 |
| Sulfur | 1.6 | 1.6 | 1.6 | 1.6 | 1.6 | 1.6 | 1.6 | 1.6 | 1.6 |
| Properties | | | | | | | | | |
| M100 at 60° C., MPa | 3.2 | 2.5 | 2.2 | 2.7 | 2.4 | 2.0 | 3.0 | 2.8 | 2.1 |
| M300 at 60° C., MPa | 11.8 | 9.1 | 7.9 | 10.6 | 9.4 | 7.1 | 13.3 | 12.7 | 10.8 |
| M300/M100 at 60° C. | 3.7 | 3.7 | 3.6 | 3.9 | 3.9 | 3.6 | 4.5 | 4.6 | 5.1 |
| Die B Tear at 23° C., KNm | 49 | 55 | 61 | 142 | 145 | 134 | 123 | 121 | 124 |
| tan δ max at 60° C. -Strain | 0.092 | 0.129 | 0.161 | 0.139 | 0.173 | 0.227 | 0.082 | 0.113 | 0.150 |
| Sweep | | | | | | | | | |
| G″ Tg, ° C. - Temp. Sweep | −51.3 | −41.9 | OL | −54.0 | −51.3 | −48.6 | −54.2 | −50.8 | −48.3 |

TABLE 9

| | 1 | 2 | 3 | 4 | 17 | 18 | 7 | 20 | 21 |
|---|---|---|---|---|---|---|---|---|---|
| Ingredient | | | | | | | | | |
| fSSBR HPR950 | 70 | 70 | 70 | | | | | | |
| BR | 30 | 30 | 30 | | | | | | |
| NR | | | | 100 | 100 | 100 | 100 | 100 | 100 |
| C9 resin | 0 | 13 | 25 | 0 | 13 | 25 | 0 | 13 | 25 |
| Z1165MP Dry Pellets | 50 | 60 | 70 | 50 | 60 | 70 | | | |
| Z1165MP Wet Pellets | | | | | | | 50 | 60 | 70 |
| N134 | 4 | 4 | 4 | 4 | 4 | 4 | 4 | 4 | 4 |
| Si69 | 5 | 6 | 7 | 5 | 6 | 7 | 5 | 6 | 7 |
| TBBS | 2.0 | 2.1 | 2.2 | 2.0 | 2.1 | 2.2 | 2.0 | 2.1 | 2.2 |
| Sulfur | 1.6 | 1.6 | 1.6 | 1.6 | 1.6 | 1.6 | 1.6 | 1.6 | 1.6 |
| Properties | | | | | | | | | |
| M100 at 60° C., MPa | 3.2 | 2.5 | 2.2 | 2.7 | 2.4 | 2.1 | 3.0 | 2.4 | 2.4 |
| M300 at 60° C., MPa | 11.8 | 9.1 | 7.9 | 10.6 | 9.0 | 7.6 | 13.3 | 11.4 | 11.5 |
| M300/M100 at 60° C. | 3.7 | 3.7 | 3.6 | 3.9 | 3.7 | 3.6 | 4.5 | 4.7 | 4.8 |
| Die B Tear at 23° C., KNm | 49 | 55 | 61 | 142 | 140 | 145 | 123 | 116 | 122 |
| tan δ max at 60° C. -Strain | 0.092 | 0.129 | 0.161 | 0.139 | 0.192 | 0.242 | 0.082 | 0.112 | 0.155 |
| Sweep | | | | | | | | | |
| G″ Tg, ° C. - Temp. Sweep | −51.3 | −41.9 | OL | −54.0 | −51.0 | −48.3 | −54.2 | −50.4 | −47.9 |

TABLE 10

| | 1 | 2 | 3 | 4 | 23 | 24 | 7 | 26 | 27 |
|---|---|---|---|---|---|---|---|---|---|
| Ingredient | | | | | | | | | |
| fSSBR HPR950 | 70 | 70 | 70 | | | | | | |
| BR CB24 | 30 | 30 | 30 | | | | | | |
| RSS3 | | | | 100 | 100 | 100 | 100 | 100 | 100 |
| C9 resin | 0 | 13 | 25 | | | | | | |
| rosin resin | | | | 0 | 13 | 25 | 0 | 13 | 25 |
| Z1165MP Dry Pellets | 50 | 60 | 70 | 50 | 60 | 70 | | | |
| Z1165MP Wet Pellets | | | | | | | 50 | 60 | 70 |
| N134 carbon black | 4 | 4 | 4 | 4 | 4 | 4 | 4 | 4 | 4 |
| Si69 | 5 | 6 | 7 | 5 | 6 | 7 | 5 | 6 | 7 |
| TBBS | 2.0 | 2.1 | 2.2 | 2.0 | 2.1 | 2.2 | 2.0 | 2.1 | 2.2 |
| Sulfur | 1.6 | 1.6 | 1.6 | 1.6 | 1.6 | 1.6 | 1.6 | 1.6 | 1.6 |
| Properties | | | | | | | | | |
| M100 at 60° C., MPa | 3.2 | 2.5 | 2.2 | 2.7 | 2.3 | 2.1 | 3.0 | 2.6 | 2.4 |
| M300 at 60° C., MPa | 11.8 | 9.1 | 7.9 | 10.6 | 8.5 | 7.8 | 13.3 | 11.5 | 10.3 |
| M300/M100 at 60° C. | 3.7 | 3.7 | 3.6 | 3.9 | 3.7 | 3.7 | 4.5 | 4.4 | 4.3 |
| Die B Tear at 23° C., KNm | 49 | 55 | 61 | 142 | 144 | 127 | 123 | 131 | 147 |
| tan δ max at 60° C. -Strain | 0.092 | 0.129 | 0.161 | 0.139 | 0.202 | 0.248 | 0.082 | 0.131 | 0.170 |
| Sweep | | | | | | | | | |
| G″ Tg, ° C. - Temp. Sweep | −51.3 | −41.9 | OL | −54.0 | −50.7 | −48.8 | −54.2 | −50.6 | −48.7 |

From Table 7, it can be seen that the wet mixing process led to NR/silica/C5 resin compositions with increased M300/M100 values and reduced hysteresis loss tan δ at 60° C. compared with NR/silica/resin dry mixed compositions. Dry mixed NR/silica compounds exhibited higher hysteresis loss tan delta at 60° C. compared with fSSBR/BR compounds. Wet mixed NR/silica compounds exhibited hysteresis loss tan delta at 60° C. that matches that of fSSBR/BR compounds. The introduction of resin into NR/silica compositions led to increased Tg (temperature at max G″ from the temperature sweep), indicative of improved wet traction performance of tires. NR/silica compositions with or without resins also exhibited much increased Die B tear strength in comparison with fSSBR/BR/silica compositions with or without resins, indicative of better tire performance under more severe service conditions such as heavy load and high stress.

From Table 8, it can be seen that the wet mixing process led to NR/silica/C5/C9 resin compositions with increased M300/M100 values and reduced hysteresis loss tan δ at 60° C. compared with NR/silica/resin dry mixed compositions. The M300/M100 ratio at 60° C. increased when the silica/resin loadings were raised. Wet-mixed NR/silica compounds exhibited hysteresis loss tan delta at 60° C. that matches that of f-SSBR/BR compounds. The introduction of resin into NR/silica compositions led to increased Tg (temperature at max G″ from the temperature sweep), indicative of improved wet traction performance of tires. NR/silica compositions with or without resins also exhibited much increased Die B tear strength in comparison with fSSBR/BR/silica compositions with or without resins, indicative of better tire performance under more severe service conditions such as heavy load and high stress.

From Table 9, it can be seen that the wet mixing process led to NR/silica/C9 resin compositions with increased M300/M100 values and reduced hysteresis loss tan δ at 60° C. compared with NR/silica/resin dry mixed compositions. The M300/M100 ratio at 60° C. increased when the silica/resin loadings were raised. Wet mixed NR/silica compounds exhibited hysteresis loss tan delta at 60° C. that matches that of fSSBR/BR compounds. The introduction of resin into NR/silica compositions led to increased Tg (temperature at max G″ from the temperature sweep), indicative of improved wet traction performance of tires. NR/silica compositions with or without resins also exhibited much increased Die B tear strength in comparison with fSSBR/BR/silica compositions with or without resins, indicative of better tire performance under more severe service conditions such as heavy load and high stress.

From Table 10, it can be seen that the wet mixing process led to NR/silica/rosin resin compositions with increased M300/M100 values and reduced hysteresis loss tan delta at 60° C. compared with NR/silica/resin dry mixed compositions. Wet mixed NR/silica compounds exhibited hysteresis loss tan delta at 60° C. that matches that of fSSBR/BR compounds. The introduction of resin into NR/silica compositions led to increased Tg (temperature at max G″ from the temperature sweep), indicative of improved wet traction performance of tires. NR/silica compositions with or without resins also exhibited much increased Die B tear strength in comparison with fSSBR/BR/silica compositions with or without resins, indicative of better tire performance under more severe service conditions such as heavy load and high stress.

Such results demonstrated that the wet mixing process can lead to resin-containing natural rubber/silica compositions with properties comparable to silica compositions containing functionalized SSBR. With improved mechanical performance and significantly enhanced hysteresis properties, wet mixed NR/silica/resin compositions can be good candidate materials for tread compounds for tires especially suitable for electrical vehicles (PC or light truck) for potentially improved treadwear and reduced rolling resistance. With low levels of resins of about 10 to 15 phr, the rubber compositions can also be used for truck treads with improved wet traction.

### Example 2

This Example describes the preparation of composites, and corresponding vulcanizates, comprising natural rubber, carbon black, and resin. Composites were prepared by dry mixing methods and wet mixing methods in which a solid elastomer was mixed with a wet filler. Each mixing method was performed with and without resin.

The carbon black used was Propel® X25 carbon black (“X25”; Cabot Corporation). The elastomer used was SMR20 natural rubber (Hokson Rubber, Malaysia). Technical descriptions of these natural rubbers are widely available, such as in Rubber World Magazine's Blue Book published by Lippincott and Peto, Inc. (Akron, Ohio, USA). Wet carbon black was prepared by milling dry carbon black pellets with an 8″ model MicroJet mill to generate fluffy carbon black particles having a 99.0% particle size diameter less than 10 μm. This fluffy carbon black was then wet pelletized in a pin pelletizer. The resulting wet carbon black (rewetted carbon black) had a moisture content of 57%. The resin used was Oppera® PR373 modifier resin, a C5/C9 resin from ExxonMobil, having a Tg=44° C. and a ring and ball softening point of 89° C.

A three-stage mixing protocol was followed to prepare dry mix reference and wet mix compounds. Stage 1 mixing protocols for the dry mix compounds and for the wet mix compounds are shown in Table 11 and Table 12, respectively. A TCU temperature of 50° C., a rotor speed of 80 rpm, and a fill factor of 70% were applied in the stage 1 dry mixing whereas a TCU temperature of 85° C., a rotor speed of 105 rpm, and fill factor of 70% in stage 1 were applied for wet mixing. For the dry mix process, resin was added with elastomer during the first stage mixing, as indicated in Table 11. The time intervals refer to the time period from the start of the mixing, defined as “0 s.”

TABLE 11

| | Temp | |
|---|---|---|
| Time (s) | (° C.) | Description |
| 0 | 50 | add polymer and resin (if any) |
| 30 | | add ⅔ carbon black |
| 90 | | add remaining carbon black |
| 120 | | Sweep |
| 180 | | add ZnO, stearic acid, 6 PPD, TMQ, wax |
| 240 | | scrape/sweep |
| 300 | 160 | dump at 300 s and adjust rpm to achieve |
| | | temp <160° C. if needed |

TABLE 12

| | Temp | |
|---|---|---|
| Time (s) | (° C.) | Description |
| 0 | 85 | add polymer |
| 30 | | add ¾ carbon black |
| 150 | 125 | sweep and add remaining carbon black at |
| | | 150 s or 125° C. |
| 190 | | Sweep |
| | 150 | add 6 PPD and resin (if any) |
| | 155 | scrape/sweep |
| | 160 | dump |

Second and third stage protocols of Tables 5 and 6 were performed for both dry and wet mixed rubber compounds. For the wet mixed composite, ZnO (3 phr), stearic acid (2 phr), 6PPD (0.5 phr), TMQ (1.5 phr), and wax (1.5 phr) were added during second stage mixing as indicated in Table 5. For the final stage mixing, curatives (1.2 phr sulfur and 1.4 phr TBBS) were added according to Table 6. Table 13 shows properties of the cured rubber compounds.

TABLE 13

| | 28 | 29 | 30 | 31 | 32 | 33 | 34 | 35 | 36 | 37 |
|---|---|---|---|---|---|---|---|---|---|---|
| Ingredient | | | | | | | | | | |
| Mixing | Dry Mix | | | | | Wet Mix | | | | |
| NR (SMR20) | 100 | 100 | 100 | 100 | 100 | 100 | 100 | 100 | 100 | 100 |
| dry CB X25 | 46 | 50 | 50 | 50 | 55 | | | | | |
| wet CB X25 | | | | | | 46 | 50 | 50 | 50 | 55 |
| C5/C9 resin | | | 5 | 10 | 10 | | | 5 | 10 | 10 |
| 6PPD | 1.5 | 1.5 | 1.5 | 1.5 | 1.5 | 1.5 | 1.5 | 1.5 | 1.5 | 1.5 |
| TMQ | 1.5 | 1.5 | 1.5 | 1.5 | 1.5 | | | | | |
| ZnO | 3.0 | 3.0 | 3.0 | 3.0 | 3.0 | | | | | |
| SA | 2.0 | 2.0 | 2.0 | 2.0 | 2.0 | | | | | |
| Wax | 1.5 | 1.5 | 1.5 | 1.5 | 1.5 | | | | | |

Properties

| | | | | | | | | | | |
|---|---|---|---|---|---|---|---|---|---|---|
| Water content | | | | | | 1.2 | 1.0 | 1.0 | 1.3 | 1.0 |
| Volume Resistivity, | 2.7 | 2.5 | 2.5 | 2.8 | 2.7 | 3.1 | 2.8 | 3.3 | 3.5 | 3.2 |
| log Ohm · cm | | | | | | | | | | |
| M100 at 23° C., MPa | 2.8 | 3.2 | 2.6 | 2.3 | 2.6 | 2.6 | 3.0 | 2.6 | 2.3 | 2.5 |
| M300 at 23° C., MPa | 16.3 | 18.2 | 15.0 | 13.1 | 14.6 | 16.7 | 18.5 | 16.8 | 14.9 | 16.0 |
| M300/M100 | 5.8 | 5.7 | 5.8 | 5.7 | 5.7 | 6.3 | 6.3 | 6.4 | 6.5 | 6.3 |
| Die B Tear at 23° C., | 183 | 163 | 179 | 177 | 184 | 169 | 163 | 144 | 151 | 133 |
| KNm | | | | | | | | | | |
| tan δ max, 60° C. - | 0.197 | 0.218 | 0.232 | 0.238 | 0.268 | 0.172 | 0.187 | 0.188 | 0.197 | 0.220 |
| Strain Sweep | | | | | | | | | | |

From the data of Table 13, it can also be seen that the wet-mixed rubber compounds, in comparison with the dry mixed counterparts, provided increased M300/M100 values and reduced hysteresis as reflected by the lower tan δ values. It can a77lso be seen that the wet-mixed rubber compounds, in comparison with the dry mixed counterparts, exhibited increased electrical resistivity. Ex. 29, which is a dry mixed compound without resin, has the lowest electrical resistivity value (log resistivity−=2.5). Adding 10 phr resin increases the resistivity of the dry mix sample (Ex. 31). The wet mix examples provide increased electrical resistivity increase particularly for the samples in which resin was added (see Ex. 35 and Ex. 36). This resistivity increase may indicate improved microdispersion of fillers from the wet mixing process.

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A method of preparing a composite, comprising:
(a) charging a mixer with at least a solid elastomer, a wet filler comprising a filler and a liquid present in an amount of at least 15% by weight based on total weight of the wet filler, and a resin;
(b) in one or more mixing steps, mixing the at least the solid elastomer, the wet filler, and the resin to form a mixture, and removing at least a portion of the liquid from the mixture by evaporation; and
(c) discharging, from the mixer, the composite comprising the filler dispersed in the elastomer at a loading of at least 20 phr, wherein the composite has a liquid content of no more than 10% by weight based on total weight of said composite.

2. The method of claim 1, wherein the resin has a T_{g} of at least 25° C.

3. The method of claim 2, wherein the resin has a T_{g} ranging from 25° C. to 110° C.

4. The method of claim 1, wherein the resin has a softening point at least 50° C., as determined according to ASTM E-28.

5. The method of claim 1, wherein the resin has a softening point ranging from 50° C. to 150° C., as determined according to ASTM E-28.

6. The method of claim 1, wherein the resin is selected from one or more of C5 resins, C5/C9 resins, C9 resins, rosin resins, terpene resins, aromatic-modified terpene resins, dicyclopentadiene resins, alkylphenol resins, and combinations thereof.

7. The method of claim 1, wherein the charging comprises charging the mixer with separate charges of the resin and the wet filler.

8. The method of claim 1, wherein the charging comprises multiple additions of the solid elastomer, the wet filler, and/or the resin.

9. The method of claim 1, wherein said mixing is performed in one mixing step.

10. The method of claim 1, wherein said mixing is performed in two or more mixing steps.

11. The method of claim 10, wherein the mixing in (b) is a second mixing step, wherein a first mixing step comprises mixing at least a portion of the solid elastomer and at least a portion of the wet filler followed by charging the mixer with the resin.

12. The method of claim 1, wherein the charging in (a) comprises charging the mixer with a mixture comprising the resin and the wet filler.

13. The method of claim 1, wherein the charging in (a) comprises charging the mixer with a co-pellet comprising the resin and the wet filler.

14. The method of claim 1, wherein in at least one of the mixing steps, the method comprises conducting said mixing wherein the mixer has at least one temperature-control means that is set to a temperature, T_{z}, of 65° C. or higher.

15. The method of claim 1, wherein in at least one of the mixing steps, the method comprises conducting said mixing with one or more rotors of the mixer operating at a tip speed of at least 0.6 m/s for at least 50% of mixing time.

16. The method of claim 1, wherein the wet filler is selected from at least one material selected from carbonaceous materials, silica, nanocellulose, lignin, clays, nanoclays, metal oxides, metal carbonates, pyrolysis carbon, graphenes, graphene oxides, reduced graphene oxide, carbon nanotubes, single-wall carbon nanotubes, multi-wall carbon nanotubes, or combinations thereof, and coated and treated materials thereof.

17. The method of claim 1, wherein the wet filler comprises silica.

18. The method of claim 1, wherein the wet filler comprises silica in an amount of at least 50% by weight relative to the total weight of the filler, and the wet filler further comprises carbon black and/or silicon-treated carbon black.

19. The method of claim 1, wherein the wet filler has a liquid present in an amount ranging from 20% to 80% by weight based on total weight of wet filler.

20. The method of claim 1, wherein the wet filler is in the form of a powder, paste, pellet, or cake.

21. The method of claim 1, wherein the charging comprises introducing dry filler into the mixer, wherein the dry filler is wetted by adding the liquid to form the wet filler in the mixer.

22. The method of claim 1, wherein the solid elastomer is selected from natural rubber, functionalized natural rubber, styrene-butadiene rubber, functionalized styrene-butadiene rubber, polybutadiene rubber, functionalized polybutadiene rubber, polyisoprene rubber, ethylene-propylene rubber, isobutylene-based elastomers, polychloroprene rubber, nitrile rubber, hydrogenated nitrile rubber, polysulfide rubber, polyacrylate elastomers, fluoroelastomers, perfluoroelastomers, silicone elastomers, and blends thereof.

23. The method of any ene of claim 1, wherein the solid elastomer is selected from natural rubber, functionalized natural rubber, styrene-butadiene rubber, functionalized styrene-butadiene rubber, polybutadiene rubber, functionalized polybutadiene rubber, and blends thereof.

24. The method of claim 1, wherein the one or more mixing steps is a continuous process.

25. The method of claim 1, wherein the one or more mixing steps is a batch process.

26. A method of preparing a composite, comprising:
(a) charging a first mixer with at least a solid elastomer and a wet filler comprising a filler and a liquid present in an amount of at least 20% by weight based on total weight of wet filler;
(b) in one or more mixing steps, mixing the at least the solid elastomer and the wet filler to form a mixture, and removing at least a portion of the liquid from the mixture by evaporation;
(c) discharging, from the first mixer, the mixture comprising the filler dispersed in the elastomer at a loading of at least 20 phr, wherein the mixture has a liquid content that is reduced to an amount less than the liquid content at the beginning of step (b), and wherein the mixture has a material temperature ranging from 100° C. to 180° C.;
(d) mixing the mixture from (c) in a second mixer to obtain the composite; and
(e) discharging, from the second mixer, the composite having a liquid content of less than 3% by weight based on total weight of said composite,
wherein a resin is charged to the first mixer, the second mixer, or both the first and second mixers.

27. The method of claim 26, wherein the resin is charged to the first mixer and step (b) comprises mixing the at least the solid elastomer, the wet filler, and the resin to form the mixture.

28. The method of claim 26, wherein the resin is charged to the second mixer and step (d) comprises mixing the mixture from (c) and the resin in the second mixer to obtain the composite.

29. The method of claim 26, wherein the first and second mixers are the same.

30. The method of claim 26, wherein the first and second mixers are different.

31. The method of claim 26, wherein the second mixer is operated under at least one of the following conditions:
(i) a ram pressure of 5 psi or less;
(ii) a ram raised to at least 75% of its highest level;
(iii) a ram operated in floating mode;
(iv) a ram positioned such that it does not substantially contact the mixture;
(v) the mixer is ram-less; and
(vi) a fill factor of the mixture ranges from 25% to 70%

32. The method of claim 31, wherein the second mixer is operated under at least one of the following conditions (i) to (vi) for at least 50% of the mixing time.

33. A method of preparing a vulcanizate, comprising:
curing the composite prepared by the method of claim 1 in the presence of at least one curing agent to form the vulcanizate.

34. An article comprising the vulcanizate prepared by the method of claim 33.
